(19) United States
(12) Patent Application Publication
(10) Pub. No.: US 2021/0395406 A1
(43) Pub. Date: Dec. 23, 2021

(54) REVERSIBLE CROSS-LINKING SYSTEM FOR POLYVINYLAMINES

(71) Applicants: SOLENIS TECHNOLOGIES, L.P., Wilmington, DE (US); Technische Universität Chemnitz, Chemnitz (DE)

(72) Inventors: Florian Taubert, Wilmington, DE (US); Lysann Kaßner, Wilmington, DE (US); Tina Uhlig, Wilmington, DE (US); Andreas Seifert, Wilmington, DE (US); Stefan Spange, Orlamünd, DE (US); Michael Sommer, Wilmington, DE (US); Christoph Hamers, Wilmington, DE (US); Hans-Joachim Haehnle, Wilmington, DE (US)

(21) Appl. No.: 17/304,579

(22) Filed: Jun. 23, 2021

Related U.S. Application Data
(60) Provisional application No. 63/042,655, filed on Jun. 23, 2020.

(51) Int. Cl. C08F 26/02; D21H 17/34; D21H 21/18; D21H 27/10

(52) U.S. Cl. CPC C08F 26/02; D21H 17/34; C08F 2810/20; D21H 27/10; D21H 21/18

(57) ABSTRACT

A vinyl amine containing polymer comprises randomly distributed repeating monomer units having at least two of the following formulae:

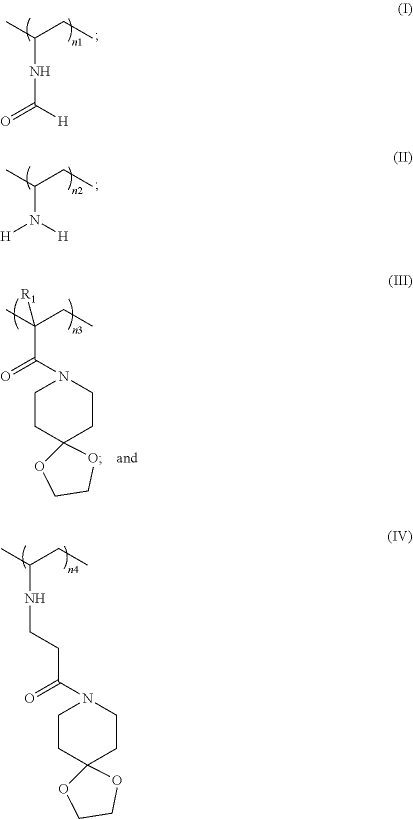

wherein, R1 is a hydrogen atom or a methyl group; and
wherein the vinyl amine containing polymer comprises repeating monomer unit III and/or IV in a total amount of from about 1.5 weight percent to about 8 weight percent based on a total weight of the polymer.

### CROSS-REFERENCE TO RELATED APPLICATIONS

This application claims the benefit of U.S. Provisional Application No. 63/042,655, filed on Jun. 23, 2020, which is incorporated by reference herein in its entirety.

### TECHNICAL FIELD

The present disclosure generally relates to a vinyl amine containing polymer. More specifically, this disclosure relates to a vinyl amine containing polymer that includes particular repeating units in a particular amount.

### BACKGROUND

For packaging paper, a task is the improvement of dry strength. Current poly-vinylamines offer improvement of dry-strength but more efficient products are required. The three main trends in packaging paper are the decrease in grammage, the use of cheaper raw materials and the decreasing quality of recycling paper. All three trends result in a decrease of dry strength. Furthermore, usage of crosslinking polymers may adversely affect the repulpability of paper. Drastic reaction conditions might be necessary to break up the cross-links. Accordingly, there remains opportunity for improvement.

### BRIEF SUMMARY

This disclosure provides a vinyl amine containing polymer comprising randomly distributed repeating monomer units having at least two of the following formulae:

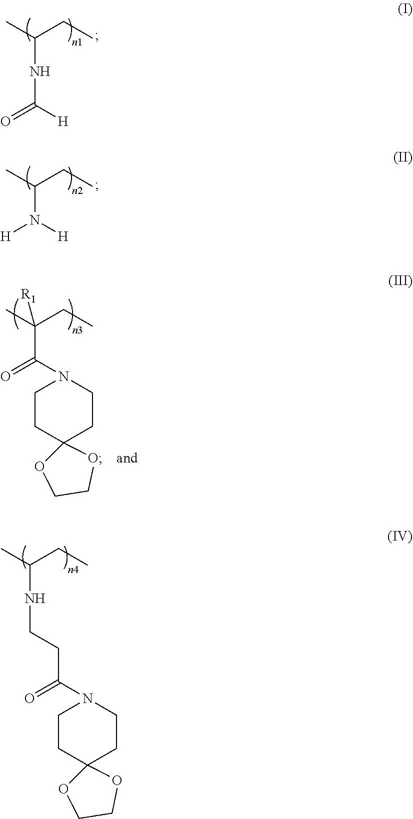

wherein, R1 is a hydrogen atom or a methyl group; and

wherein the vinyl amine containing polymer comprises repeating monomer unit III and/or IV in a total amount of from about 1.5 weight percent to about 8 weight percent based on a total weight of the polymer.

This disclosure also provides a method of making the polymer wherein the method comprises the steps of:

reacting a polyvinyl amine and/or vinyl formamide based compound and a compound having a piperidine moiety to form an intermediate; and

acidifying the intermediate to form the polymer.

### BRIEF DESCRIPTION OF THE DRAWINGS

The present disclosure will hereinafter be described in conjunction with the following drawing figures, wherein like numerals denote like elements, and

FIG. 1 shows 13C-NMR spectra of model compounds and the cross-linking reaction of OBP and PVAm: a) model compound from OBP and 1,3-diaminopropane in solvent CDCl3, b) solid state 13C-NMR spectrum of crosslinked PVAm with OBP, c) solid state 13C-NMR spectrum of PVAm reacted with N-acetylpiperidin-4-one, d) solid state 13C-NMR spectrum of PVAm.

FIG. 2 shows 13C-NMR spectra of model compounds and the cross-linking reaction of TBP and PVAm: a) model compound from TBP and 1,3-diaminopropane in solvent CDCl3, b) solid state 13C-NMR spectrum of crosslinked PVAm with TBP, c) solid state 13C-NMR spectrum of PVAm.

FIG. 3 is a series of photographs that show a reversibility experiment of crosslinked polyvinylamine wherein addition of hydrochloric acid induces the liquefaction of the gel and subsequent sodium hydroxide addition leads to gelation.

FIG. 4 shows a series of 13C-NMR spectra of example 2.1 reacted with N-acetylpiperidin-4-one.

FIG. 5 shows the 13C-NMR spectra of Example 2.1 crosslinked with OBP in water wherein the PVAm gel was prepared in situ in the NMR tube and measured by liquid NMR spectroscopy.

FIG. 6 is a photograph that shows polyvinylamine gels crosslinked with OBP and colored with methylene blue and rhodamine B.

FIG. 7 is a photograph that show a fused polyvinylamine gel.

FIG. 8 shows a) cross-linking polyvinylamine (PVAm) with bispiperidone derivatives in water-OBP: oxalyl-bispiperidinone, TBP: terephthalyl-bis-piperidinone wherein the reaction is pH-dependent, with cross-linking occurring at neutral to basic pH and the back reaction being promoted under acidic conditions; b) gelated PVAm with OBP, c) acidified PVAm gel, d) re-gelated PVAm gel, e), f) temperature-induced joining of two gels.

FIG. 9 shows representative solid state ¹³C NMR spectra of a) OBP, b) its model compound with DAPe, c) PVAm and NAP, d) PVAm and OBP and e) PVAm.

FIG. 10 shows a solid state ¹³C NMR spectrograph of precipitated gels of PVAm cross-linked with OBP. PVAm solutions were adjusted to different pH, cross-linked and precipitated.

FIG. 11 is a summary of typical reactions of a,c) NAP and b,d) OBP with amines to explain the chemistry of PVAm wherein HA and A denote hemiaminal and aminal, respectively.

FIG. 12 shows oscillatory shear rheology of PVAm hydrogels cross-linked with OBP with varying degrees of cross-linking (1, 3 and 5 mol %) and a water content of 94 wt %.

FIG. 13 shows regions of ¹H-NMR (I) and ¹³C-NMR (II) spectra of variable temperature NMR measurements of N-acetylpiperidin-4-one (NAP) in tetrachloroethane-d₂ (*) @Bruker DRX 250.

FIG. 14 is a ¹H- and ¹³C NMR spectra of OBP in D₂O (*) @Bruker Avance Neo 600.

FIG. 15 is a ¹³C NMR spectra of piperidone derivatives in solution (D₂O) and in the gel state @ Bruker Avance Neo 600 (I, II, III) and @Bruker Fourier 300HD

FIG. 16 shows sections of the 13C NMR spectra of I) 1,2-bis(2,4-dimenthyl-1,5,9-triazaspiro[5.5]undecan-9-yl)ethane-1,2-dione, and II)1-(2,4-dimenthyl-1,5,9-triazaspiro[5.5] undecane-9-yl)ethanone in the range from 37 to 46 ppm measured in CDCl₃ @Bruker Avance Neo 600.

FIG. 17 shows possible stereoisomers of the model compound 1-(2,4-dimethyl-1,5,9-triazaspiro[5.5]undecan-9-yl)ethanone that can form at room temperature.

FIG. 18 shows a higher degree of ionization of simple amines that provides an explanation for NAP or OBP being unreactive towards DAPr and DAPe at neutral pH, wherein at pH=12 the aminal is furnished quantitatively.

FIG. 19 shows ¹³C NMR spectra of I) PVAm (Lupamin1595) crosslinked with OBP and measured in the gel state and II) PVAm (Lupamin1595) reacted with NAP at acidic, neutral and basic pH.

FIG. 20 shows the ¹³C CP MAS NMR spectra of isolated PVAm-OBP gels wherein the gels were prepared at pH 7 and with different OBP concentrations.

FIG. 21 is a ¹³C NMR spectra of PVAm reacted with NAP with different NH₂:C═O ratios at pH=7 and measured in DMSO-d₆/H₂O @Bruker Avance Neo 600.

FIG. 22 is a ¹³C NMR spectra of PVAM-OBP gel measured in DMSO-d₆/H₂O at different temperatures and pH=7 @Bruker Fourier 300HD.

FIG. 23 is a ¹³C NMR spectra of PVAm reacted with NAP in DMSO-d₆/H₂O changing the pH from neutral to acidic and again to neutral @Bruker Avance Neo 600.

FIG. 24 is a ¹H NMR spectrum of DAPe in CDCl₃(*)@Bruker Avance Neo 600.

FIG. 25 is a ¹³C NMR spectrum of DAPe in CDCl₃ @Bruker Avance Neo 600.

FIG. 26 is a ¹H-¹³C HSQC NMR spectrum of DAPe in CDCl₃(*) @Bruker Avance Neo 600.

FIG. 27 is a ¹H ¹H COSY NMR spectrum of DAPe in CDCl₃(*) @Bruker Avance Neo 600.

FIG. 28 is a ¹H NMR spectra of 1-(1,5,9-triazaspiro[5.5]undecan-9-yl)ethanone (I) and 1-(2,4-dimethyl-1,5,9-triazaspiro[5.5]undecan-9-yl)ethanone (II) in CDCl₃ @Bruker Avance Neo 600.

FIG. 29 is a ¹H ¹H COSY NMR spectrum of 1-(2,4-dimethyl-1,5,9-triazaspiro[5.5]undecan-9-yl)ethanone in CDCl₃ @Bruker Avance Neo 600.

FIG. 30 is a ¹³C NMR spectra of 1-(1,5,9-triazaspiro[5.5]undecan-9-yl)ethanone (I) and 1-(2,4-dimethyl-1,5,9-triazaspiro[5.5]undecan-9-yl)ethanone (II) in CDCl₃ (*), #methylene chloride.

FIG. 31 is a section of the ¹³C NMR spectrum of 1-(2,4-dimethyl-1,5,9-triazaspiro[5.5]undecan-9-yl)ethanone in the range from 37 to 46 ppm.

FIG. 32 is a ¹H-¹³C HSQC NMR spectrum of 1-(2,4-dimethyl-1,5,9-triazaspiro[5.5]undecan-9-yl)ethanone in CDCl₃ @Bruker Avance Neo 600.

FIG. 33 is a ¹H NMR spectrum of 1,2-bis(2,4-dimethyl-1,5,9-triazaspiro[5.5]undecan-9-yl)ethane-1,2-dione in CDCl₃ @Bruker Avance Neo 600.

FIG. 34 is a ¹H ¹H COSY NMR spectrum of 1,2-bis(2,4-dimethyl-1,5,9-triazaspiro[5.5]undecan-9-yl)ethane-1,2-dione in CDCl₃.

FIG. 35 is a ¹³C NMR spectrum of 1,2-bis(2,4-dimethyl-1,5,9-triazaspiro[5.5]undecan-9-yl)ethane-1,2-dione in CDCl₃ (*), #methylene chloride, DAPe @Bruker Avance Neo 600.

FIG. 36 is a section of the ¹³C NMR spectrum of 1,2-bis(2,4-dimethyl-1,5,9-triazaspiro[5.5]undecan-9-yl)ethane-1,2-dione in the range from 36 to 46 ppm. ˜DAPe @Bruker Avance Neo 600.

FIG. 37 is a ¹H-¹³C HSQC NMR spectrum of 1,2-bis(2,4-dimethyl-1,5,9-triazaspiro[5.5]undecan-9-yl)ethane-1,2-dione in CDCl₃ @Bruker Avance Neo 600.

### DETAILED DESCRIPTION

This disclosure provides a reversible cross-linking system for polyvinylamines. This cross-linking system is typically fully reversible, and the cross-links can be easily broken by a simple change in pH or temperature. Finally, this crosslinking system is applicable to a wide range of applications like encapsulation, glues, thickeners, cross-linking of water based dispersion for coatings or water based lacquer, self-healing systems, rheological additives, drug delivery, recyclable thermosets.

The present disclosure provides a cross-linking system for aqueous media. The system typically includes polymers having vinylamine units and a cross-linker having piperidone units. The cross-linking system can be either a two- or one-component system. In one embodiment, the system includes mixtures of aqueous solutions of a vinylamine comprising polymer and a cross-linker having at least two piperidone units. In another embodiment, the system includes aqueous solutions of co-polymers are applied comprising vinylamine and piperidone units simultaneously, e.g. as shown below.

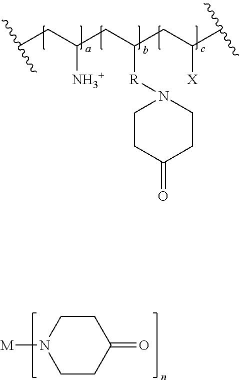

Unexpectedly the carbonyl group of the piperidone and the amino-group of the vinylamine units form stable hemi-aminals in aqueous solutions which results in cross-linking. Typically, no stable hemi-aminals are observed in aqueous solutions for a ketone/amine combination.

This reaction occurs in equilibrium where pH and temperature determine whether the equilibrium shifts towards adduct formation or hemi-aminal. Therefore, each system has a specific window relative to pH and temperature in which cross-linking occurs. Outside of this window, cross-links are hydrolysed. Typically, high pH and low temperatures favor hemi-aminal formation while low pH and high temperature favor adduct formation.

While in the aqueous solution, hardly any aminal structures are present because hemi-aminals are converted to aminals only if water is removed for example by drying. Typical reaction equilibria are shown below:

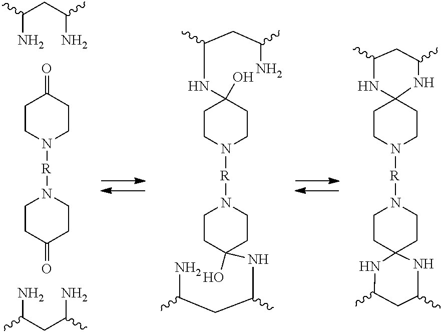

Therefore, the cross-linking of these systems can simply be triggered by a change in temperature or pH. Reversing one or both parameters lead to hydrolysis of the cross-links.

In other embodiments, the disclosure provides a system that includes one or more of the following:

Monomers having piperidone units or piperidone units with protected carbonyl functions, especially ketals;

Water soluble cross-linker having piperidone units;

Copolymers having piperidone units or piperidone units with protected carbonyl functions, especially ketals; and/or

Water soluble polymers having piperidone units and vinylamine units;

In other embodiments, the disclosure provides:

Methods to synthesize the above compounds;

The process of cross-linking;

Usage for a wide range of applications, especially paper making; and/or

Products generated by these cross-linking processes.

Monomers having piperidone units or piperidone moieties with protected carbonyl functions, especially ketals, may have the following structure:

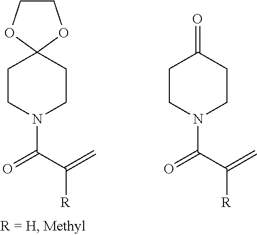

These monomers are prepared by reacting (meth) acrylic-acid-chlorides or -anhydrides with piperidone or its derivatives with a carbonyl group in a protected form, especially as ketals (see examples 1.4-1.6). The form with the protected carbonyl group is typical due to the fact that copolymerization of VFA with the unprotected monomer (AP) failed (see comparative example 2.16-2.18).

Water soluble cross-linkers having piperidone moieties can be prepared by reacting multifunctional carboxylic acid chlorides with piperidone (examples 1.1 and 1.2). Instead of acid chlorides, the use of anhydrides is also contemplated. Another synthetic route is the reaction of piperidone with multifunctional epoxides (example 1.3).

There are also other possible routes to create such cross-linkers including:

Michael addition of multifunctional acrylate to piperidone;

Reaction of piperidone with multifunctional isocyanates;

Reactions of piperidone with multifunctional carboxylic esters; and

Reaction of piperidone with multifunctional aliphatic halogenides or tosylates.

An alternative route is the preparation of polymers having piperidone units by homo-co-polymerisation of monomers of type a) optionally followed by removal of the protective group. Monomers used in co-polymerization should be either inert to the reaction conditions used to remove the protective group or create under these conditions functional groups which do not interfere with the cross-linking reaction.

Examples of various cross-linkers include N-vinylpyrrolidone od N-vinylcaprolactame, N-tert.-butyl-acrylamide, DADMAC, AMPS. Examples of other cross-linkers include vinylacetate, vinylformate, acrylic or methacrylic esters like methyl (meth) acrylate, ethyl (meth)acrylate, hydroxyethyl or propyl(met) acrylate, and combinations thereof, Furthermore, the monomer composition typically has to be chosen in such a way, that the final polymer cross-linker is still water soluble.

Water soluble polymers having piperidone units also typically include vinylamine units. These polymers are typically prepared by co-polymerization of a N-vinylcarboxamide (typically N-vinylformamide) with one of the monomers having a piperidone unit with a protected carbonyl group. A typical protection group is the ketal. Optionally additional monomers can be added. A detailed description of these optional monomers are given in US 20170362776, which is expressly incorporated herein by reference in its entirety in various non-limiting embodiments.

In other embodiments, an amide of a carboxamide and a protective group of a carbonyl group can be completely or partially removed by acidic hydrolysis typically with hydrochloric acid. The reaction is typically run in such a way that the protective group is removed completely while the amide is removed >10 mol %. More typical is the removal of the amide >30 mol % and most typical is >50%. Various reaction schemes are set forth below:

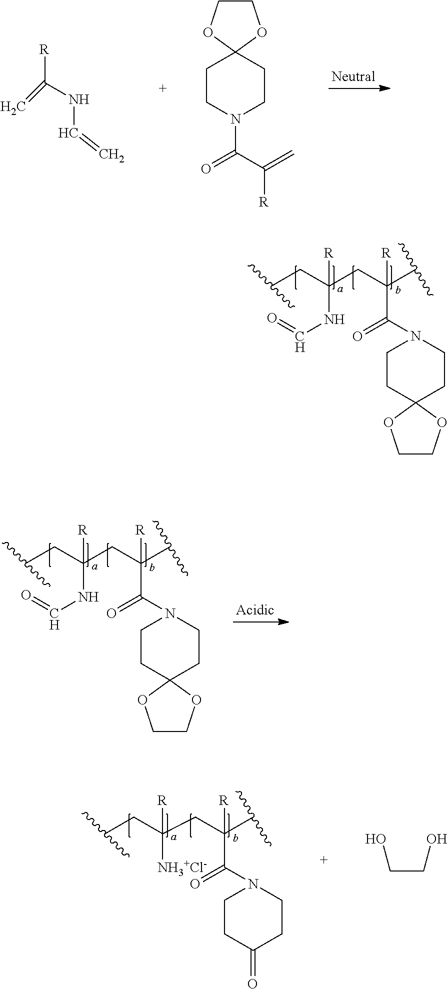

wherein each R is independently a hydrogen atom or a methyl group.

During the hydrolysis step, some of the piperidone units may split off the polymer backbone by an anchimeric effect of neighboring amino-groups as shown below:

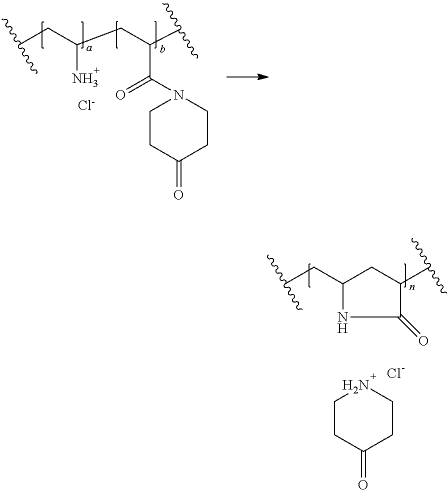

Nevertheless, this method enables the synthesis of effective cross-linking systems.

An alternative route to prepare such polymers is the Michael addition of an acrylate type monomer with a protected carbonyl group to a vinylamine-units having polymer followed by an acidic removal of the protection group again typically by hydrochloric acid:

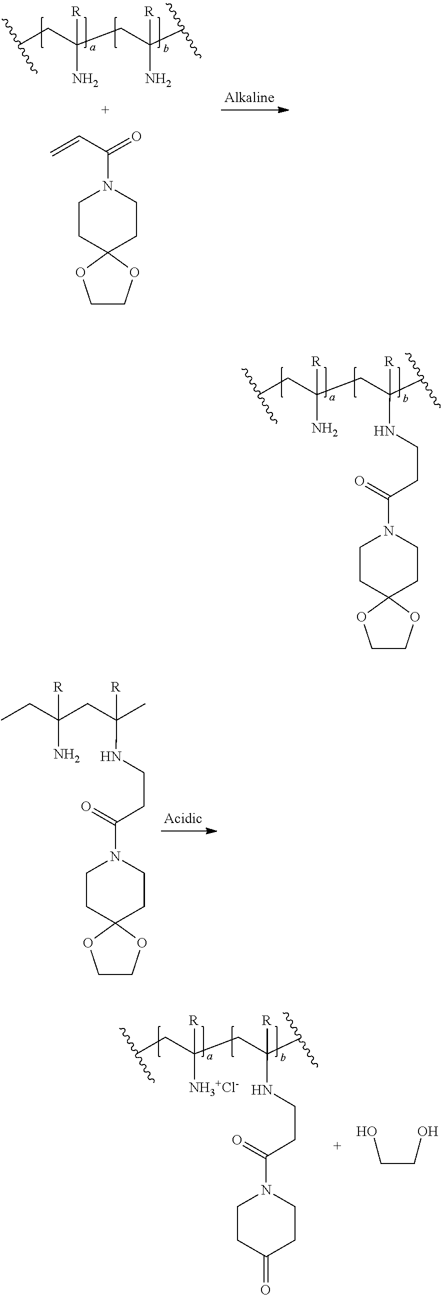

The polymer having vinylamine units can comprise other monomers. A detailed description of potential monomers is given in US 20170362776, which is expressly incorporated herein by reference in its entirety in various non-limiting embodiments.

Furthermore, the vinylamine group having polymer can be modified optionally before, during or after the above Michael addition by other Michael addition reactions. A detailed description of such optional modifications is given in U.S. Pat. No. 8,604,134, which is expressly incorporated herein by reference in its entirety in various non-limiting embodiments.

In various embodiments, the following cross-linking options are contemplated for use herein:

| System | pH-Triggered | Temperature Triggered | No Trigger |
|---|---|---|---|
| 1-Component | Very Typical | Less Typical | Not Typical |
| 2 Component | Very Typical | Typical | Very Typical |

In one embodiment, e.g. a one component system, pH triggered, an aqueous solution of a polymer type can be used. During synthesis and storage, the pHs of these systems are at a level where no cross-linking happens. Then the pH is increased above the cross-linking pH and the hemi-aminals are formed creating a gel. The cross-linking pH is individual for each system and can be adjusted by a number of parameters listed below.

In another embodiment, e.g. a two-component system, pH triggered, an aqueous mixture of a vinylamine comprising polymer and a cross-linker can be used. During preparation and storage, the pH of these systems is at a level where no crosslinking happens. Then the pH is increased above the cross-linking pH and the hemi-aminals are formed creating the cross-links. The cross-linking pH is individual for each system and can be adjusted by a number of parameters listed below.

In a further embodiment, e.g. a one component system, temperature triggered, an aqueous solution of a polymer type can be used. In this case the system has to be handled and stored above a cross-linking temperature. By decreasing the temperature below the cross-linking temperature, the cross-linking is initiated. The cross-linking pH is individual for each system and can be adjusted by a number of parameters listed below.

In yet another embodiment, e.g. a two-component system, temperature triggered, two differing variants are possible. Starting with an aqueous mixture of a vinylamine comprising polymer and a cross-linker, the same procedure as described above can be followed. Such a system may have to be stored at higher temperatures for example at 70° C. Another variant is to store and handle the polymer and the cross-linker separately at room temperature. When applying the system, the aqueous polymer solution can be heated to a temperature above the cross-linking temperature and the cross-linker is mixed in. Cross-linking is initiated by lowering the temperature below a cross-linking temperature. The cross-linking temperature is individual for each system and can be adjusted by a number of parameters listed below.

In another embodiment, e.g. a two-component system, without a trigger, a cross-linker can be added to the vinylamine comprising polymer at a pH and temperature which facilitates the cross-linking.

Each system has its own operational window concerning pH and temperature, which can be adjusted by: functionality of the cross-linker; ratio of amino-units in the polymer; ratio of piperidone units versus amino groups; molecular weight of the polymer; concentration of the cross-linker and polymer in the aqueous solution; and/or combinations thereof. For paper making the typical pH range for cross-linking is 6-8 and the temperature is RT to 50° C.

In various embodiment, the polymers and/or systems of this disclosure can be used in a wide range of applications including, but not limited to, glues, thickeners, cross-linking of water-based dispersion for coatings or water based lacquer, self-healing systems, rheological additives, drug delivery, recyclable thermosets and paper making. In paper making, the polymers and/or systems can be used as dry strength agent, especially for packaging papers.

### Additional Embodiments

In various embodiments, this disclosure provides a composition comprising: a polyvinyl amine having the structure:

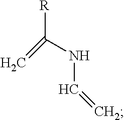

and
a first compound having a piperidine moiety and having the structure:

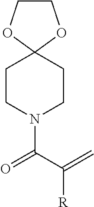

wherein each R is independently a hydrogen atom or a methyl group. In one embodiment, each R is a methyl group. In another embodiment, each R is a hydrogen atom. In another embodiment, the R of the polyvinyl amine is a methyl group and the R of the first compound having the piperidine moiety is a hydrogen atom. In another embodiment, the R of the polyvinyl amine is a hydrogen atom and the R of the first compound having the piperidine moiety is a methyl group.

This disclosure also provides a method of making a polymer comprising the steps of:

reacting the polyvinyl amine and the first compound having the piperidine moiety of claim 1 to form a first intermediate;

acidifying the first intermediate to form the polymer having the structure:

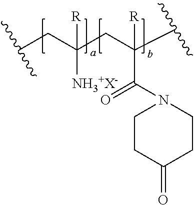

wherein each R is independently a hydrogen atom or a methyl group and wherein X⁻ may be any anion.

In other embodiments, this disclosure provides a method of making paper comprising the step of applying the polymer to pulp or in any portion or step of the papermaking process. It is contemplated that any polymer described herein may be utilized in a papermaking process.

In other embodiments, this disclosure provides a composition comprising

a vinyl formamide based compound having the structure:

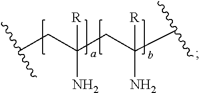

and

a second compound having a piperidine moiety and having the structure:

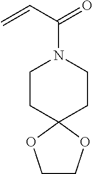

wherein each R is independently a hydrogen atom or a methyl group. For example, each R can be a methyl group. Alternatively, each R can be a hydrogen atom. Alternatively, one R can be a methyl group and the other R can be a hydrogen atom.

In other embodiments, this disclosure provides a method of making a polymer comprising the steps of:

reacting the vinyl formamide based compound and the second compound having the piperidine moiety of claim 1 to form a second intermediate;

acidifying the second intermediate to form the polymer having the structure:

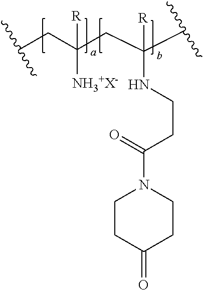

wherein each R is independently a hydrogen atom or a methyl group and wherein X⁻ may be any anion.

In other embodiments, this disclosure provides a vinyl amine containing polymer comprising randomly distributed repeating monomer units having at least two of the following formulae:

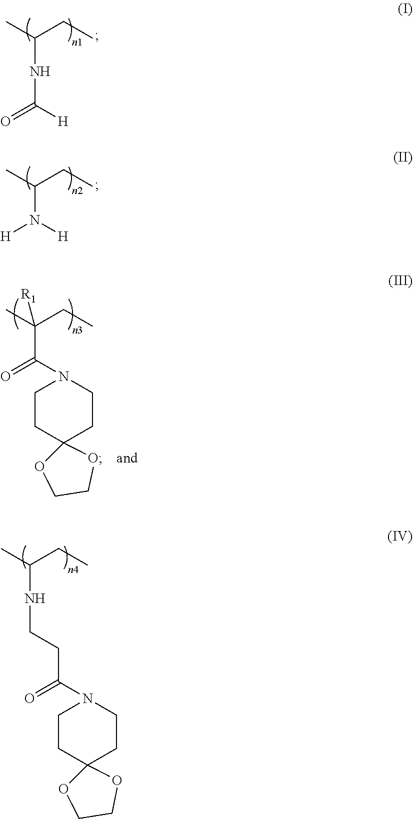

wherein, R1 is a hydrogen atom or a methyl group; and

wherein the vinyl amine containing polymer comprises repeating monomer unit III and/or IV in a total amount of from about 1.5 weight percent to about 8 weight percent based on a total weight of the polymer.

This disclosure also provides a method of making the polymer wherein the method comprises the steps of:

reacting a polyvinyl amine and/or vinyl formamide based compound and a compound having a piperidine moiety to form an intermediate; and

acidifying the intermediate to form the polymer.

In one embodiment, repeating monomer unit (I) is present. In another embodiment, repeating monomer unit (II) is present. In another embodiment, repeating monomer unit (III) is present. In another embodiment, repeating monomer unit (IV) is present. In another embodiment, repeating monomer unit (I) is absent. In another embodiment, repeating monomer unit (II) is absent. In another embodiment, repeating monomer unit (III) is absent. In another embodiment, repeating monomer unit (IV) is absent. All combinations of the presence/absence of repeating monomers (I), (II), (III), and (IV) are hereby expressly contemplated so long as the vinyl amine containing polymer comprises repeating monomer unit III and/or IV in a total amount of from about 1.5 weight percent to about 8 weight percent based on a total weight of the polymer.

In other embodiments, R1 is a methyl group. Alternatively, R1 is a hydrogen atom.

In various embodiments, the repeating monomer unit III and/or IV is present in a total amount of from about 1.5 to about 8, about 2 to about 7.5, about 2.5 to about 7, about 3 to about 6.5, about 3.5 to about 6, about 4 to about 5.5, or about 5 to about 5.5, weight percent based on a total weight of the polymer. For example, in one embodiment, the repeating monomer unit III and/or IV is present in a total amount of from about 2 weight percent to about 6 weight percent based on a total weight of the polymer. In another embodiment, the repeating monomer unit III and/or IV is present in a total amount of from about 2 weight percent to about 4 weight percent based on a total weight of the polymer. In another embodiment, the repeating monomer unit III and/or IV is present in a total amount of from about 4 weight percent to about 6 weight percent based on a total weight of the polymer. In another embodiment, the repeating monomer unit III and/or IV is present in a total amount of from about 6 weight percent to about 8 weight percent based on a total weight of the polymer. In various non-limiting embodiments, all values and ranges of values, both whole and fractional, including and between those values described above, are hereby expressly contemplated for use herein.

### EXAMPLES

K values were measured as described in H. Fikentscher, Cellulosechemie, volume 13, 48-64 and 71-74 under the particular conditions specified.

The percentages in the examples are percent by weight, unless otherwise stated.

Solids contents of samples were quantified by 0.5 to 1.5 g of the polymer solution being distributed in a 4 cm diameter tin lid and then dried at 140° C. in a circulating air-drying cabinet for two hours. The ratio of the mass of the sample after drying under the above conditions to the mass at sample taking is the solids content of the samples.

The water used in the examples was completely ion-free.

The degree of hydrolysis is the mol % fraction of hydrolyzed VFA units, based on the VFA units originally present in the polymer.

The degree of hydrolysis of the hydrolyzed homopolymers/copolymers of N-vinylformamide was quantified by enzymatic analysis of the formates/formic acid released in the hydrolysis (test kit from Boehringer Mannheim)

The following abbreviations are used.

DCM: Dichloromethane

VFA: N-Vinylformamide

VP: N-Vinylpyrrolidone

### 1. Cross-Linker and Monomers

### Example 1.1 1,2-bis(4-oxopiperidin-1-yl)ethane-1,2-dione (OBP)

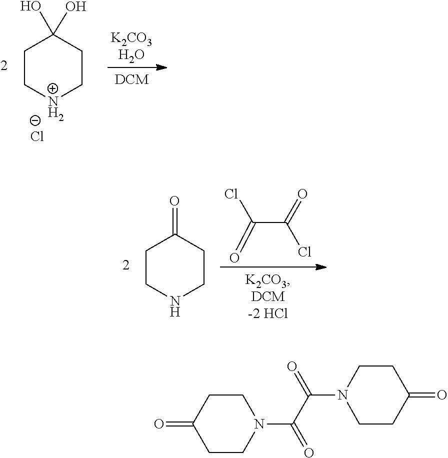

4-Piperidone monohydrate hydrochloride (7.7 g, 0.047 mol) and K2CO3 (9.6 g, 0.05 mol) were dissolved in 30 ml water and stirred for 30 minutes. Then, the free 4-piperidone base was extracted from the aqueous phase by liquid-liquid extraction with 750 mL dichloromethane (DCM) by means of a perforator for 24 h. Then, the organic phase was dried with anhydrous MgSO4 and filtered, then the most part of the solvent is removed by rotary evaporation. A few milliliters of solvent should remain in the flask. The crude DCM solution is then added immediately to a mixture of K2CO3 (12.4 g, 0.09 mol) and 250 ml dry dichloromethane under stirring at argon atmosphere. Oxalylchloride (2.9 g, 0.023 mol) was added dropwise to the DCM solution in the reactor vessel while cooling the with an ice bath. Afterwards, the reaction mixture was stirred 24 h by room temperature. Then, the organic solution was filtered and the filtrate was washed with a portion (20 mL) of 5% aqueous NaHCO₃ solution. Then the organic phase was dried with MgSO4. After filtration the solvent was evaporated until it is completely dry by using a rotary evaporator. The final product OBP was obtained as white solid.

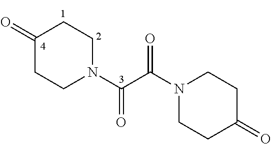 [SMILES: O=C1CCN(C(=O)C(=O)N2CCC(=O)CC2)CC1]

Yield 63% of theory with respect to 4-Piperidone monohydrate hydrochloride

Melting point: 174° C.

1H NMR (CDCl₃): 2.50 (t, 4H, H-1), 2.53 (t, 4H, H-1), 3.67 (t, 4H, H-2), 3.87 (t, 4H, H-2). 13C NMR (CDCl₃): 40.5 (C-2), 40.6 (C-1), 41.3 (C-1), 45.1 (C-2), 162.8 (C-3), 205.4 (C-4) Quantitative elemental analysis calcd (%) for C12H16N2O4 Molecular Weight: 252.27 g/mol C: 57.13H: 6.39 N: 11.10 found: C: 56.73H: 6.33 N: 10.86.

### Example 1.2 1,1′-Terephthaloylbis(piperidin-4-one) (TBP)

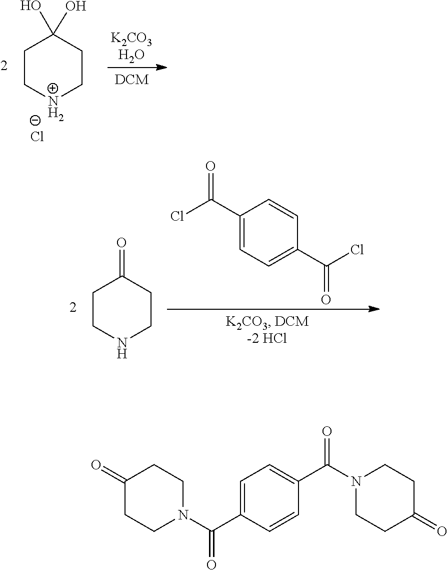 [SMILES: OC1(O)CC[NH2+]CC1 ; [Cl-] ; O=C1CCNCC1 ; O=C(Cl)c1ccc(C(=O)Cl)cc1 ; O=C1CCN(C(=O)c2ccc(C(=O)N3CCC(=O)CC3)cc2)CC1]

4-Piperidone monohydrate hydrochloride (7.7 g, 0.047 mol) and K2CO3 (9.6 g, 0.05 mol) were dissolved in 30 ml and stirred for 30 minutes. Then, the free 4-piperidone base was extracted from the aqueous phase by liquid-liquid extraction with 750 mL dichloromethane (DCM) by means of a perforator for 24 h. Then, the organic phase was dried with anhydrous MgSO4 and filtered, then the most part of the solvent is removed by rotary evaporation. A few milliliters of solvent should remain in the flask. The crude DCM solution is then added immediately to a mixture of K2CO3 (12.4 g, 0.09 mol) and 250 ml dry dichloromethane under stirring at argon atmosphere. Terephtaloylchloride (4.7 g, 0.023 mol), suspended in 50 mL dry dichloromethane, was added dropwise to the DCM solution in the reactor vessel while cooling the with an ice bath. Afterwards, the reaction mixture was stirred 24 h by room temperature. Then, the organic solution was filtered and the filtrate was washed with a portion (20 mL) of 5% aqueous NaHCO₃ solution. Then the organic phase was dried with MgSO4. After filtration the solvent was evaporated until it is completely dry by using a rotary evaporator. The final product TBP was obtained as white solid.

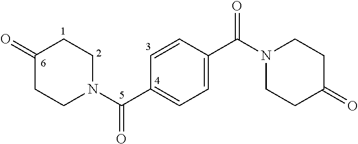 [SMILES: O=C1CCN(C(=O)c2ccc(C(=O)N3CCC(=O)CC3)cc2)CC1]

Yield 52% of theory with respect to 4-Piperidone monohydrate hydrochloride

Melting point: 265° C.

1H NMR (CDCl₃): 2.36-2.54 (8H, H-1), 3.66-3.97 (8H, H-2), 7.79 (s, 4H, H-3).

13C NMR (CDCl₃): 40.8 (C-1), 41.3 (C-1), 41.6 (C-2), 46.3 (C-2), 127.3 (C-3), 137.0 (C-4), 169.6 (C-5), 206.3 (C-6).

Quantitative elemental analysis calcd (%) for C18H20N2O4 Molecular Weight: 328.36 g/mol C: 65.84H: 6.14 N: 8.53 found: C: 64.80H: 6.04 N: 8.29.

### Example 1.3 Poly(Ethylene Glycol) Dipiperidone PEDP

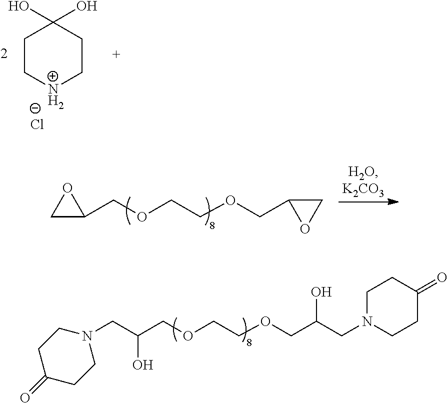

Poly(ethylene glycol) diglycidylether (18.9 g, 0.036 mol, Mn=526 g/mol) in aqueous solution was cooled to 0° C. A mixture of 4-piperidone monohydrate hydrochloride (12.4 g, 0.08 mol) and K2CO3 (5.5 g, 0.04 mol) in 40 mL water was added dropwise. The reaction mixture was stirred overnight and then extracted with 100 mL dichloromethane. The organic phase was dried with MgSO4, evaporated and the product was obtained as yellow liquid.

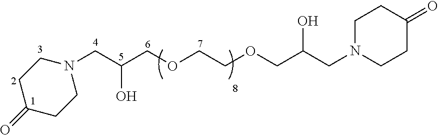

Yield: 84%

1H NMR (CDCl₃): 2.40-2.58 (8H, H-2), 2.59-2.69 (4H, H-4), 2.74-3.08 (8H, H-3), 3.44-3.56 (4H, H-6), 3.58-3.81 (32H, H-7), 3.89-4.10 (2H, H-5).

13C NMR (CDCl₃): 41.1 (C2), 53.4 (C3), 59.5 (C4), 67.2 (C5), 70.4 (C7), 73.8 (C6), 208.6 (C1).

### Example 1.4 Synthesis of APK

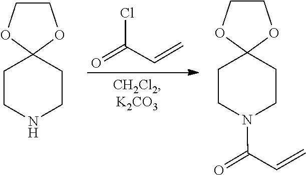

Acryloyl chloride (3.6 g, 0.04 mol) was added dropwise to a mixture of 4-Piperidinone-ethylene ketal (5.1 g, 0.04 mol) and solid K2CO3 (11.1 g, 0.08 mol) in 50 mL dry dichloromethane. The reaction mixture was stirred 24 h by room temperature. Then the mixture was filtered and the filtrate was washed with an aqueous NaHCO₃ solution. Organic phase was dried with MgSO4, evaporated and the product APK was obtained as yellow liquid. According to GC-measurement the product was 94% pure.

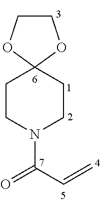

Yield 42%

1H NMR (CDCl₃): 1.65 (t, 4H, H-1), 3.56 (t, 2H, H-2), 3.68 (t, 2H, H-2), 3.91 (4H, H-3), 5.60 (dd, 1H, H-4), 6.19 (dd, 1H, H-4), 6.53 (dd, 1H, H-5).

13C NMR (CDCl₃): 34.3 (C-1), 35.7 (C-1), 40.1 (C-2), 43.8 (C-2), 64.5 (C-3), 106.9 (C-6), 127.6 (C-4), 127.7 (C-5), 165.3 (C-7).

### Example 1.5 Synthesis of MAPK

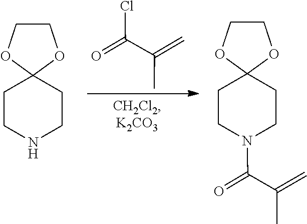

Methacryloyl chloride (3.6 g, 0.04 mol) was added dropwise to a mixture of 4-Piperidinone-ethylene ketal (5.1 g, 0.04 mol) and K2CO3 (11.1 g, 0.08 mol) in 50 mL dry dichloromethane. The reaction mixture was stirred 24 h by room temperature. Then the mixture was filtered and the filtrate was washed with an aqueous NaHCO₃ solution. Organic phase was dried with MgSO4, evaporated and the product MAPK was obtained as yellow liquid. According to GC it was 89% pure.

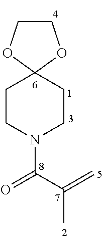

Yield 69%

1H NMR (CDCl₃): 1.63 (m, 4H, H-1), 1.89 (s, 3H, H-2), 3.53 (2H, H-3), 3.64 (2H, H-3), 3.91 (4H, H-4), 4.96 (d, 1H, H-5), 5.09 (d, 1H, H-5).

13C NMR (CDCl₃): 20.4 (C-2), 34.7 (C-1), 35.7 (C-1), 39.9 (C-3), 44.6 (C-3), 64.4 (C-4), 106.7 (C-6), 115.0 (C-5), 140.2 (C-7), 171.1 (C-8).

### Example 1.6 Synthesis of AP

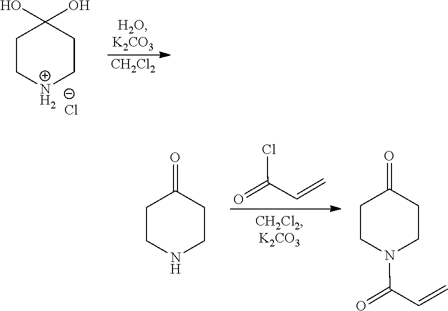

4-Piperidone monohydrate hydrochloride (7.7 g, 0.047 mol) and K2CO3 (9.6 g, 0.05 mol) were dissolved in 30 ml water and were stirred for 30 minutes. Then, the free 4-piperidone base was extracted from the aqueous phase by liquid-liquid extraction with 750 mL dichloromethane (DCM) by means of a perforator for 24 h. Then, the organic phase was dried with anhydrous MgSO4 and filtered, then the most part of the solvent is removed by rotary evaporation. A few milliliters of solvent should remain in the flask. Then the solution was added to a mixture of K2CO3 (12.4 g, 0.09 mol) and 250 ml dried dichloromethane and was stirred under argon atmosphere. Acryloyl chloride (4.2 g, 0.046 mol) was added dropwise while cooling the reactor vessel with an ice bath. The reaction mixture was stirred 24 h by room temperature. Then the mixture was filtered. The filtrate was evaporated and the product AP was obtained as yellow liquid. It is pure with respect to the integral intensities of NMR analysis.

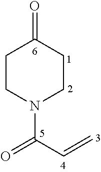

Yield 56%

1H NMR (CDCl₃): 2.33-2.43 (m, 4H, H-1), 3.70-3.90 (m, 4H, H-2), 5.65 (dd, 1H, H-5), 6.22 (dd, 1H, H-6), 6.55 (dd, 1H, H-4)

13C NMR (CDCl₃): 40.6-41.0 (C-1, C-2), 44.1 (C-2), 127.0 (C-3), 128.6 (C4), 165.5 (C5), 206.4 (C6).

### 2. Polymers

Preparations of polymers were carried out in two or three steps:

1) polymerization

2) hydrolysis of polymers, and optionally

3) polymer-analogous reaction

### Example 2.1 Homopolymer VFA, Fully Hydrolysed

### a) Polymerization

Feed 1 was provided by providing 234 g of N-vinylformamide.

Feed 2 was provided by dissolving 1.2 g of 2,2′-azobis(2-methylpropionamidine) dihydrochloride in 56.8 g of water at room temperature.

A 2 l glass apparatus fitted with anchor stirrer, descending condenser, internal thermometer and nitrogen inlet tube was initially charged with 1080.0 g of water and 2.5 g of 75 wt % phosphoric acid. 2.1 g of 25 wt % aqueous sodium hydroxide solution were admixed at a speed of 100 rpm, attaining pH 6.6. The initial charge was heated to 73° C. and the pressure in the apparatus was reduced sufficiently for the reaction mixture to just start to boil at 73° C. (about 350 mbar). Feeds 1 and 2 were then started at the same time. At a constant 73° C., feeds 1 and 2 were added, respectively, over one hour and 15 minutes and over 2 hours. On completion of the admixture of feed 2, the reaction mixture was post-polymerized at 73° C. for a further three hours. During the entire polymerization and post-polymerization, about 190 g of water were distilled off. The batch was subsequently cooled down to room temperature under atmospheric pressure.

The precursor obtained was a slightly yellow, viscous solution having a solids content of 19.7 wt %. The K value of the polymer was 90 (0.5 wt % in water)

### b) Hydrolysis

300.0 g of the above precursor were placed in a 1 l four-neck flask fitted with blade stirrer, internal thermometer, dropping funnel and reflux condenser and heated to 80° C. at a stirrer speed of 80 rpm. Then, 157.3 g of 25 wt % aqueous sodium hydroxide solution were admixed. The mixture was maintained at 80° C. for three hours. The product obtained was cooled down to room temperature.

A slightly yellow polymer solution was obtained with a polymer content of 7.0% The degree of hydrolysis of the vinylformamide units was 100 mol %.

### Example 2.2Homopolymer VFA, 50 Mol % Hydrolysed

### a) Polymerisation

Feed 1 was provided by providing 234 g of N-vinylformamide.

Feed 2 was provided by dissolving 1.2 g of 2,2′-azobis(2-methylpropionamidine) dihydrochloride in 56.8 g of water at room temperature.

A 2 l glass apparatus fitted with anchor stirrer, descending condenser, internal thermometer and nitrogen inlet tube was initially charged with 1080.0 g of water and 2.5 g of 75 wt % phosphoric acid. 2.1 g of 25 wt % aqueous sodium hydroxide solution were admixed at a speed of 100 rpm, attaining pH 6.6. The initial charge was heated to 73° C. and the pressure in the apparatus was reduced sufficiently for the reaction mixture to just start to boil at 73° C. (about 350 mbar). Feeds 1 and 2 were then started at the same time. At a constant 73° C., feeds 1 and 2 were added, respectively, over one hour and 15 minutes and over 2 hours. On completion of the admixture of feed 2, the reaction mixture was post-polymerized at 73° C. for a further three hours. During the entire polymerization and post-polymerization, about 190 g of water were distilled off. The batch was subsequently cooled down to room temperature under atmospheric pressure.

The precursor obtained was a slightly yellow, viscous solution having a solids content of 19.7 wt %. The K value of the polymer was 90 (0.5 wt % in water)

### b) Hydrolysis

400.0 g of the above precursor were placed in a 1 l four-neck flask fitted with blade stirrer, internal thermometer, dropping funnel and reflux condenser and heated to 80° C. at a stirrer speed of 80 rpm. Then, 87.4 g of 25 wt % aqueous sodium hydroxide solution were admixed. The mixture was maintained at 80° C. for three hours. The product obtained was cooled down to room temperature and adjusted to pH 7.0 with 39.8 g of 37 wt % hydrochloric acid.

A slightly yellow polymer solution was obtained with a polymer content of 11.8%. The degree of hydrolysis of the vinylformamide units was 50 mol %.

### Example 2.3Homopolymer VFA, 30 Mol % Hydrolysed

### a) Polymerization

Feed 1 was provided by providing 234 g of N-vinylformamide.

Feed 2 was provided by dissolving 1.2 g of 2,2′-azobis(2-methylpropionamidine) dihydrochloride in 56.8 g of water at room temperature.

A 2 l glass apparatus fitted with anchor stirrer, descending condenser, internal thermometer and nitrogen inlet tube was initially charged with 1080.0 g of water and 2.5 g of 75 wt % phosphoric acid. 2.1 g of 25 wt % aqueous sodium hydroxide solution were admixed at a speed of 100 rpm, attaining pH 6.6. The initial charge was heated to 73° C. and the pressure in the apparatus was reduced sufficiently for the reaction mixture to just start to boil at 73° C. (about 350 mbar). Feeds 1 and 2 were then started at the same time. At a constant 73° C., feeds 1 and 2 were added, respectively, over one hour and 15 minutes and over 2 hours. On completion of the admixture of feed 2, the reaction mixture was post-polymerized at 73° C. for a further three hours. During the entire polymerization and post-polymerization, about 190 g of water were distilled off. The batch was subsequently cooled down to room temperature under atmospheric pressure.

The precursor obtained was a slightly yellow, viscous solution having a solids content of 19.7 wt %. The K value of the polymer was 90 (0.5 wt % in water)

### b) Hydrolysis

603.3 g of the above precursor were placed in a 1 l four-neck flask fitted with blade stirrer, internal thermometer, dropping funnel and reflux condenser, admixed with 8.6 g of 40 wt % aqueous sodium bisulfite solution, and then heated to 80° C., at a stirrer speed of 80 rpm. Then, 94.9 g of 25% aqueous sodium hydroxide solution were admixed. The mixture was maintained at 80° C. for 3 hours. The product obtained was cooled down to room temperature and adjusted to pH 7.0 with 31.7 g of 37 wt % hydrochloric acid.

A slightly yellow polymer solution was obtained with a polymer content of 10.6% The degree of hydrolysis of the polymerized vinylformamide units was 30 mol %.

### Example 2.4 Copolymer VFA/Sodium-Acrylate=70/30 (Molar), VFA Fully Hydrolysed Polymerization

Feed 1 was provided by providing a mixture of 100.0 g of water, 224.6 g of aqueous 32 wt % sodium acrylate solution adjusted to pH 6.4 and 128.0 g of N-vinylformamide.

Feed 2 was provided by dissolving 0.9 g of 2,2′-azobis(2-methylpropionamidine) dihydrochloride in 125.8 g of water at room temperature.

A 2 l glass apparatus fitted with anchor stirrer, descending condenser, internal thermometer and nitrogen inlet tube was initially charged with 407 g of water and 1.9 g of 85 wt % phosphoric acid. About 3.7 g of 25 wt % aqueous sodium hydroxide solution were admixed at a speed of 100 rpm, attaining pH 6.6. The initial charge was heated to 80° C. and the pressure in the apparatus was reduced sufficiently for the reaction mixture to just start to boil at 80° C. (about 450 mbar). Feeds 1 and 2 were then started at the same time. At a constant 80° C., feeds 1 and 2 were added, respectively, over 1.5 h and over 2.5 hours. On completion of the admixture of feed 2, the reaction mixture was post-polymerized at 80° C. for a further 2.5 hours. During the entire polymerization and post-polymerization, about 143 g of water were distilled off. The batch was subsequently cooled down to room temperature under atmospheric pressure.

The precursor obtained was a slightly yellow, viscous solution having a solids content of 23.8 wt %. The K value of the copolymer was 90 (0.5 wt % in 5 wt % aqueous NaCl solution).

### b) Hydrolysis

847.2 g of the above precursor were placed in a 2 l four-neck flask fitted with blade stirrer, internal thermometer, dropping funnel and reflux condenser, admixed with 9.3 g of 40 wt % aqueous sodium bisulfite solution, and then heated to 80° C., at a stirrer speed of 80 rpm. Then, 313.7 g of 25% aqueous sodium hydroxide solution were admixed. The mixture was maintained at 80° C. for 7 hours. The product obtained was cooled down to room temperature and adjusted to pH 8.5 with 117.0 kg of 37 wt % hydrochloric acid.

A slightly yellow polymer solution was obtained with a polymer content of 10.1%. The degree of hydrolysis of the vinylformamide units was 100 mol %.

### Example 2.5 Copolymer VFA/APK=98.5/1.5 (Molar), VFA 92% Hydrolysed

### a) Polymerization

Feed 1 was provided by mixing 9.9 g APK and 230.5 g N-vinylformamide.

Feed 2 was provided by dissolving 1.2 g of 2,2′-azobis(2-methylpropionamidine) dihydrochloride in 58.3 g of water at room temperature.

Feed 3 was 200 g of water

A 2 l glass apparatus fitted with anchor stirrer, descending condenser, internal thermometer and nitrogen inlet tube was initially charged with 1080 g of water and 2.2 g of 85 wt % phosphoric acid. About 3.9 g of 25 wt % aqueous sodium hydroxide solution were admixed at a speed of 100 rpm, attaining pH 6.7. The initial charge was heated to 73° C. and the pressure in the apparatus was reduced sufficiently for the reaction mixture to just start to boil at 73° C. (about 350 mbar). Feeds 1, 2 and 3 were then started at the same time. At a constant 73° C., feeds 1 was added over 1.25 hours while feed 2 and 3 were added over 2.0 hours. On completion of the admixture of feed 2 and 3, the reaction mixture was post-polymerized at 73° C. for a further 3.5 hours. During the entire polymerization and post-polymerization, about 170 g of water were distilled off. The batch was subsequently cooled down to room temperature under atmospheric pressure.

The precursor was a clear, colorless, viscous solution having a solids content of 17.3 wt %. The K value of the copolymer was 87 (0.5 wt % in aqueous solution).

### b) Hydrolysis

150 g of the above precursor were placed in a 500 ml four-neck flask fitted with blade stirrer, internal thermometer, dropping funnel and reflux condenser and heated to 80° C. At a stirrer speed of 80 rpm 33.9 g of 37 wt % hydrochloric acid were over 2 min. The mixture was maintained at 80° C. for 4 hours. The product obtained was cooled down to room temperature

A yellow, clear, viscous polymer solution was obtained with a polymer content of 8.7%. The degree of hydrolysis of the vinylformamide units was 92 mol %. 1H-NMR confirmed, that the ketal group was fully removed.

### Example 2.6 Copolymer VFA/APK=98.5/1.5 (Molar), VFA 65% Hydrolysed

### a) Polymerization

Feed 1 was provided by mixing 9.9 g APK and 230.5 g N-vinylformamide.

Feed 2 was provided by dissolving 1.2 g of 2,2′-azobis(2-methylpropionamidine) dihydrochloride in 58.3 g of water at room temperature.

Feed 3 was 200 g of water

A 2 l glass apparatus fitted with anchor stirrer, descending condenser, internal thermometer and nitrogen inlet tube was initially charged with 1080 g of water and 2.2 g of 85 wt % phosphoric acid. About 3.9 g of 25 wt % aqueous sodium hydroxide solution were admixed at a speed of 100 rpm, attaining pH 6.7. The initial charge was heated to 73° C. and the pressure in the apparatus was reduced sufficiently for the reaction mixture to just start to boil at 73° C. (about 350 mbar). Feeds 1, 2 and 3 were then started at the same time. At a constant 73° C., feeds 1 was added over 1.25 hours while feed 2 and 3 were added over 2.0 hours. On completion of the admixture of feed 2 and 3, the reaction mixture was post-polymerized at 73° C. for a further 3.5 hours. During the entire polymerization and post-polymerization, about 170 g of water were distilled off. The batch was subsequently cooled down to room temperature under atmospheric pressure.

The precursor was a clear, colorless, viscous solution having a solids content of 17.3 wt %. The K value of the copolymer was 87 (0.5 wt % in aqueous solution).

### b) Hydrolysis

150 g of the above precursor were placed in a 500 ml four-neck flask fitted with blade stirrer, internal thermometer, dropping funnel and reflux condenser and heated to 80° C. At a stirrer speed of 80 rpm 20.4 g of 37 wt % hydrochloric acid were over 2 min. The mixture was maintained at 80° C. for 4 hours. The product obtained was cooled down to room temperature.

A yellow, clear, viscous polymer solution was obtained with a polymer content of 10.9%. The degree of hydrolysis of the vinylformamide units was 65 mol %. 1H-NMR confirmed, that the ketal group was fully removed.

### Example 2.7 Copolymer VFA/APK=97/3 (Molar), VFA 92% Hydrolysed

### a) Polymerization

Feed 1 was provided by mixing 19.9 g APK and 221.7 g N-vinylformamide.

Feed 2 was provided by dissolving 1.2 g of 2,2′-azobis(2-methylpropionamidine) dihydrochloride in 58.4 g of water at room temperature.

Feed 3 was 200 g of water

A 2 l glass apparatus fitted with anchor stirrer, descending condenser, internal thermometer and nitrogen inlet tube was initially charged with 1080 g of water and 2.2 g of 85 wt % phosphoric acid. About 3.9 g of 25 wt % aqueous sodium hydroxide solution were admixed at a speed of 100 rpm, attaining pH 6.7. The initial charge was heated to 73° C. and the pressure in the apparatus was reduced sufficiently for the reaction mixture to just start to boil at 73° C. (about 350 mbar). Feeds 1, 2 and 3 were then started at the same time. At a constant 73° C., feeds 1 was added over 1.25 hours while feed 2 and 3 were added over 2.0 hours. On completion of the admixture of feed 2 and 3, the reaction mixture was post-polymerized at 73° C. for a further 3.5 hours. During the entire polymerization and post-polymerization, about 170 g of water were distilled off. The batch was subsequently cooled down to room temperature under atmospheric pressure.

The precursor was a clear, colorless, viscous solution having a solids content of 17.5 wt %. The K value of the copolymer was 88 (0.5 wt % in aqueous solution).

### b) Hydrolysis

150 g of the above precursor were placed in a 500 ml four-neck flask fitted with blade stirrer, internal thermometer, dropping funnel and reflux condenser and heated to 80° C. At a stirrer speed of 80 rpm 36.5 g of 37 wt % hydrochloric acid were over 2 min. The mixture was maintained at 80° C. for 4 hours. The product obtained was cooled down to room temperature

A yellow, clear, viscous polymer solution was obtained with a polymer content of 8.6%. The degree of hydrolysis of the vinylformamide units was 92 mol %. 1H-NMR confirmed, that the ketal group was fully removed.

### Example 2.8 Copolymer VFA/APK=97/3 (Molar), VFA 51% Hydrolysed Polymerization

Feed 1 was provided by mixing 19.9 g APK and 221.7 g N-vinylformamide.

Feed 2 was provided by dissolving 1.2 g of 2,2′-azobis(2-methylpropionamidine) dihydrochloride in 58.4 g of water at room temperature.

Feed 3 was 200 g of water

A 2 l glass apparatus fitted with anchor stirrer, descending condenser, internal thermometer and nitrogen inlet tube was initially charged with 1080 g of water and 2.2 g of 85 wt % phosphoric acid. About 3.9 g of 25 wt % aqueous sodium hydroxide solution were admixed at a speed of 100 rpm, attaining pH 6.7. The initial charge was heated to 73° C. and the pressure in the apparatus was reduced sufficiently for the reaction mixture to just start to boil at 73° C. (about 350 mbar). Feeds 1, 2 and 3 were then started at the same time. At a constant 73° C., feeds 1 was added over 1.25 hours while feed 2 and 3 were added over 2.0 hours. On completion of the admixture of feed 2 and 3, the reaction mixture was post-polymerized at 73° C. for a further 3.5 hours. During the entire polymerization and post-polymerization, about 170 g of water were distilled off. The batch was subsequently cooled down to room temperature under atmospheric pressure.

The precursor was a clear, colorless, viscous solution having a solids content of 17.5 wt %. The K value of the copolymer was 88 (0.5 wt % in aqueous solution).

### b) Hydrolysis

150 g of the above precursor were placed in a 500 ml four-neck flask fitted with blade stirrer, internal thermometer, dropping funnel and reflux condenser and heated to 80° C. At a stirrer speed of 80 rpm 16.6 g of 37 wt % hydrochloric acid were over 2 min. The mixture was maintained at 80° C. for 4 hours. The product obtained was cooled down to room temperature

A yellow, clear, viscous polymer solution was obtained with a polymer content of 11.9%. The degree of hydrolysis of the vinylformamide units was 51 mol %. 1H-NMR confirmed, that the ketal group was fully removed.

### Example 2.9 Copolymer VFA/APK=95/5 (Molar), VFA 100% Hydrolysed

### a) Polymerization

Feed 1 was provided by mixing 32.1 g APK and 210.1 g N-vinylformamide.

Feed 2 was provided by dissolving 1.2 g of 2,2′-azobis(2-methylpropionamidine) dihydrochloride in 58.4 g of water at room temperature.

Feed 3 was 200 g of water

A 2 l glass apparatus fitted with anchor stirrer, descending condenser, internal thermometer and nitrogen inlet tube was initially charged with 1077 g of water and 2.2 g of 85 wt % phosphoric acid. About 3.9 g of 25 wt % aqueous sodium hydroxide solution were admixed at a speed of 100 rpm, attaining pH 6.7. The initial charge was heated to 73° C. and the pressure in the apparatus was reduced sufficiently for the reaction mixture to just start to boil at 73° C. (about 350 mbar). Feeds 1, 2 and 3 were then started at the same time. At a constant 73° C., feeds 1 was added over 1.25 hours while feed 2 and 3 were added over 2.0 hours. On completion of the admixture of feed 2 and 3, the reaction mixture was post-polymerized at 73° C. for a further 3.5 hours. During the entire polymerization and post-polymerization, about 170 g of water were distilled off. The batch was subsequently cooled down to room temperature under atmospheric pressure.

The precursor was a lightly turbid, colorless, viscous solution having a solids content of 17.5 wt %. The K value of the copolymer was 88 (0.5 wt % in aqueous solution).

### b) Hydrolysis

150 g of the above precursor were placed in a 500 ml four-neck flask fitted with blade stirrer, internal thermometer, dropping funnel and reflux condenser and heated to 80° C. At a stirrer speed of 80 rpm 34.4 g of 37 wt % hydrochloric acid were over 2 min. The mixture was maintained at 80° C. for 4 hours. The product obtained was cooled down to room temperature

A yellow, clear, viscous polymer solution was obtained with a polymer content of 8.0%. The degree of hydrolysis of the vinylformamide units was 100 mol %. 1H-NMR confirmed, that the ketal group was fully removed.

### Example 2.10 Copolymer VFA/APK=95/5 (Molar), VFA 46% Hydrolysed

### a) Polymerization

Feed 1 was provided by mixing 32.1 g APK and 210.1 g N-vinylformamide.

Feed 2 was provided by dissolving 1.2 g of 2,2′-azobis(2-methylpropionamidine) dihydrochloride in 58.4 g of water at room temperature.

Feed 3 was 200 g of water

A 2 l glass apparatus fitted with anchor stirrer, descending condenser, internal thermometer and nitrogen inlet tube was initially charged with 1077 g of water and 2.2 g of 85 wt % phosphoric acid. About 3.9 g of 25 wt % aqueous sodium hydroxide solution were admixed at a speed of 100 rpm, attaining pH 6.7. The initial charge was heated to 73° C. and the pressure in the apparatus was reduced sufficiently for the reaction mixture to just start to boil at 73° C. (about 350 mbar). Feeds 1, 2 and 3 were then started at the same time. At a constant 73° C., feeds 1 was added over 1.25 hours while feed 2 and 3 were added over 2.0 hours. On completion of the admixture of feed 2 and 3, the reaction mixture was post-polymerized at 73° C. for a further 3.5 hours. During the entire polymerization and post-polymerization, about 170 g of water were distilled off. The batch was subsequently cooled down to room temperature under atmospheric pressure.

The precursor was a lightly turbid, colorless, viscous solution having a solids content of 17.5 wt %. The K value of the copolymer was 88 (0.5 wt % in aqueous solution).

### b) Hydrolysis

150 g of the above precursor were placed in a 500 ml four-neck flask fitted with blade stirrer, internal thermometer, dropping funnel and reflux condenser and heated to 80° C. At a stirrer speed of 80 rpm 15.6 g of 37 wt % hydrochloric acid were over 2 min. The mixture was maintained at 80° C. for 4 hours. The product obtained was cooled down to room temperature

A yellow, clear, viscous polymer solution was obtained with a polymer content of 11.9%. The degree of hydrolysis of the vinylformamide units was 46 mol %. 1H-NMR confirmed, that the ketal group was fully removed.

### Example 2.11 Copolymer VFA/APK=92/8 (Molar), VFA 94% Hydrolysed

### a) Polymerization

Feed 1 was provided by mixing 49.0 g APK and 194.0 g N-vinylformamide.

Feed 2 was provided by dissolving 1.2 g of 2,2′-azobis(2-methylpropionamidine) dihydrochloride in 58.4 g of water at room temperature.

Feed 3 was 200 g of water

A 2 l glass apparatus fitted with anchor stirrer, descending condenser, internal thermometer and nitrogen inlet tube was initially charged with 1077 g of water and 2.6 g of 85 wt % phosphoric acid. About 3.9 g of 25 wt % aqueous sodium hydroxide solution were admixed at a speed of 100 rpm, attaining pH 6.5. The initial charge was heated to 73° C. and the pressure in the apparatus was reduced sufficiently for the reaction mixture to just start to boil at 73° C. (about 350 mbar). Feeds 1, 2 and 3 were then started at the same time. At a constant 73° C., feeds 1 was added over 1.25 hours while feed 2 and 3 were added over 2.0 hours. On completion of the admixture of feed 2 and 3, the reaction mixture was post-polymerized at 73° C. for a further 3.5 hours. During the entire polymerization and post-polymerization, about 170 g of water were distilled off. The batch was subsequently cooled down to room temperature under atmospheric pressure.

The precursor was a lightly turbid, colorless, viscous solution having a solids content of 17.6 wt %. The K value of the copolymer was 86 (0.5 wt % in aqueous solution).

### b) Hydrolysis

150 g of the above precursor were placed in a 500 ml four-neck flask fitted with blade stirrer, internal thermometer, dropping funnel and reflux condenser and heated to 80° C. At a stirrer speed of 80 rpm 31.9 g of 37 wt % hydrochloric acid were over 2 min. The mixture was maintained at 80° C. for 4 hours. The product obtained was cooled down to room temperature

A yellow, clear, viscous polymer solution was obtained with a polymer content of 8.2%. The degree of hydrolysis of the vinylformamide units was 94 mol %. 1H-NMR confirmed, that the ketal group was fully removed.

### Example 2.12 Copolymer VFA/APK=92/8 (Molar), VFA 51% Hydrolysed

### a) Polymerization

Feed 1 was provided by mixing 49.0 g APK and 194.0 g N-vinylformamide.

Feed 2 was provided by dissolving 1.2 g of 2,2′-azobis(2-methylpropionamidine) dihydrochloride in 58.4 g of water at room temperature.

Feed 3 was 200 g of water

A 2 l glass apparatus fitted with anchor stirrer, descending condenser, internal thermometer and nitrogen inlet tube was initially charged with 1077 g of water and 2.6 g of 85 wt % phosphoric acid. About 3.9 g of 25 wt % aqueous sodium hydroxide solution were admixed at a speed of 100 rpm, attaining pH 6.5. The initial charge was heated to 73° C. and the pressure in the apparatus was reduced sufficiently for the reaction mixture to just start to boil at 73° C. (about 350 mbar). Feeds 1, 2 and 3 were then started at the same time. At a constant 73° C., feeds 1 was added over 1.25 hours while feed 2 and 3 were added over 2.0 hours. On completion of the admixture of feed 2 and 3, the reaction mixture was post-polymerized at 73° C. for a further 3.5 hours. During the entire polymerization and post-polymerization, about 170 g of water were distilled off. The batch was subsequently cooled down to room temperature under atmospheric pressure.

The precursor was a lightly turbid, colorless, viscous solution having a solids content of 17.6 wt %. The K value of the copolymer was 86 (0.5 wt % in aqueous solution).

### b) Hydrolysis

150 g of the above precursor were placed in a 500 ml four-neck flask fitted with blade stirrer, internal thermometer, dropping funnel and reflux condenser and heated to 80° C. At a stirrer speed of 80 rpm 14.5 g of 37 wt % hydrochloric acid were over 2 min. The mixture was maintained at 80° C. for 4 hours. The product obtained was cooled down to room temperature and 1.2 g of 37 wt % hydrochloric acid added.

A yellow, clear, viscous polymer solution was obtained with a polymer content of 11.2%. The degree of hydrolysis of the vinylformamide units was 51 mol %. 1H-NMR confirmed, that the ketal group was fully removed.

### Example 2.13 Copolymer VFA/APK=92/8 (Molar), VFA 21% Hydrolysed

### a) Polymerization

Feed 1 was provided by mixing 49.0 g APK and 194.0 g N-vinylformamide.

Feed 2 was provided by dissolving 1.2 g of 2,2′-azobis(2-methylpropionamidine) dihydrochloride in 58.4 g of water at room temperature.

Feed 3 was 200 g of water

A 2 l glass apparatus fitted with anchor stirrer, descending condenser, internal thermometer and nitrogen inlet tube was initially charged with 1077 g of water and 2.6 g of 85 wt % phosphoric acid. About 3.9 g of 25 wt % aqueous sodium hydroxide solution were admixed at a speed of 100 rpm, attaining pH 6.5. The initial charge was heated to 73° C. and the pressure in the apparatus was reduced sufficiently for the reaction mixture to just start to boil at 73° C. (about 350 mbar). Feeds 1, 2 and 3 were then started at the same time. At a constant 73° C., feeds 1 was added over 1.25 hours while feed 2 and 3 were added over 2.0 hours. On completion of the admixture of feed 2 and 3, the reaction mixture was post-polymerized at 73° C. for a further 3.5 hours. During the entire polymerization and post-polymerization, about 170 g of water were distilled off. The batch was subsequently cooled down to room temperature under atmospheric pressure.

The precursor was a lightly turbid, colorless, viscous solution having a solids content of 17.6 wt %. The K value of the copolymer was 86 (0.5 wt % in aqueous solution).

### b) Hydrolysis

150 g of the above precursor were placed in a 500 ml four-neck flask fitted with blade stirrer, internal thermometer, dropping funnel and reflux condenser and heated to 80° C. At a stirrer speed of 80 rpm 5.8 g of 37 wt % hydrochloric acid were over 2 min. The mixture was maintained at 80° C. for 4 hours. The product obtained was cooled down to room temperature and 1.6 g of 37 wt % hydrochloric acid added.

A yellow, clear, viscous polymer solution was obtained with a polymer content of 13.3%. The degree of hydrolysis of the vinylformamide units was 21 mol %. 1H-NMR confirmed, that the ketal group was fully removed.

### Example 2.14 Copolymer VFA/MAPK=95/5 (Molar), VFA 53% Hydrolysed

### a) Polymerization

Feed 1 was provided by dissolving 0.8 g of 2,2′-azobis(2,4-dimethylvaleronitrile) in 45.0 g of ethyl-acetate at room temperature.

Feed 2 was 100 g of ethyl-acetate

A 1 l glass apparatus fitted with anchor stirrer, descending condenser, internal thermometer and nitrogen inlet tube was initially charged with 300 g ethyl-acetate, 143.9 g VFA and 25.0 MAPK. The initial charge was heated to 79° C. while nitrogen was fed into the solution to remove oxygen. At 79° C. 4 g of feed 1 were added to start the polymerization. After 40 min another 4 g of feed 1 were added. 1.5 h after the first shot of feed 1 a third portion (5 g) of feed 1 were added. Finally, 2 h after the first shot the remaining feed 1 was added to the reactor over 2 h and 15 min. About 30 min later a highly viscous white suspension was achieved, which was diluted by adding feed 2 in 3 min, After the end of the final feed 1 the reaction mixture held for another 30 min ad 79° C. and finally cooled to room temperature. The white precipitate was filtered off, washed twice with ethyl-acetate and dried overnight in a vacuum oven at 80° C. and 50 mbar.

The obtained precursor was a white powder having a solids content of 98.8%. The K-value of the copolymer was 67 (0.5 wt % in aqueous solution).

### b) Hydrolysis

22.8 g of the white powder were dissolved in 127.2 g of water and placed in a 500 ml four-neck flask fitted with blade stirrer, internal thermometer, dropping funnel and reflux condenser: the solution was heated to 80° C. At a stirrer speed of 80 rpm 13.4 g of 37 wt % hydrochloric acid were over 2 min. The mixture was maintained at 80° C. for 4 hours. The product obtained was cooled down to room temperature.

A yellow, clear polymer solution was obtained with a polymer content of 10.0%. The degree of hydrolysis of the vinylformamide units was 53 mol %. 1H-NMR confirmed, that the ketal group was fully removed.

An investigation of the gained products revealed that during hydrolysis of Examples 2.5-2.14 in addition to the expected reactions—hydrolysis of VFA-units and removal of the ketal groups—

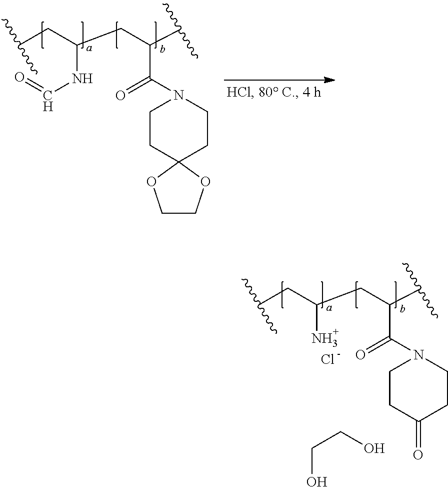

the following reaction occurred:

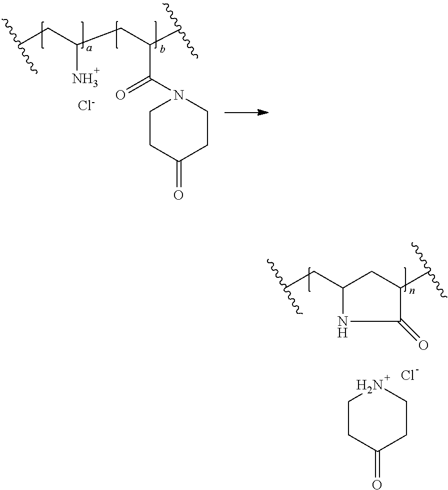

Therefore, only a part of the piperidone units remained attached to the polymer backbones. By means of HPLC measurements the amount of free piperidone hydrochloride in the products was measure and the composition of the final products calculated:

TABLE 1

| | Original | Original: | | | |
|---|---|---|---|---|---|
| | VFA- | (M)APK- | Degree of | pH of | Ratio of |
| | ratio | ratio | hydrolysis | final | hydrolysed |
| Example | [mol %] | [mol %] | VFA [%]: | product | APK [%]: |
| 2.5 | 98.5 | 1.5 | 92.4 | 0.3 | 91 |
| 2.6 | 98.5 | 1.5 | 64.9 | 1.2 | 75 |
| 2.7 | 97.0 | 3.0 | 91.7 | 0.4 | 85 |
| 2.8 | 97.0 | 3.0 | 50.9 | 1.6 | 73 |
| 2.9 | 95.0 | 5.0 | 100.0 | 0.3 | 93 |
| 2.10 | 95.0 | 5.0 | 46.3 | 1.7 | 80 |
| 2.11 | 92.0 | 8.0 | 93.8 | 0.0 | 90 |
| 2.12 | 92.0 | 8.0 | 50.7 | 1.3 | 72 |
| 2.13 | 92.0 | 8.0 | 21.0 | 2.1 | 24 |
| 2.14 | 95 | 5* | 53 | 1.5 | 74 |

| | | Vinyla- | | |
|---|---|---|---|---|
| | VFA | mine | (M)APK | Lactam |
| Example | [mol %] | [mol %] | [mol %] | [mol %] |
| 2.5 | 7.6 | 90.9 | 0.2 | 1.3 |
| 2.6 | 35.0 | 63.5 | 0.4 | 1.1 |
| 2.7 | 8.3 | 88.6 | 0.4 | 2.7 |
| 2.8 | 48.7 | 48.3 | 0.8 | 2.2 |
| 2.9 | 0.0 | 94.8 | 0.3 | 4.9 |
| 2.10 | 53.1 | 41.7 | 1.0 | 4.2 |
| 2.11 | 6.1 | 85.2 | 0.9 | 7.8 |
| 2.12 | 48.2 | 43.3 | 2.3 | 6.2 |
| 2.13 | 74.20 | 17.7 | 6.2 | 1.9 |
| 2.14 | 46.3 | 48.6 | 1.3 | 3.8 |

### Example 2.15 Michael Addition of 1 Mol % APK to Vinylamine Followed by Hydrolysis of the Ketal Group

### a) Michael Addition of 1 Mol % APK on Amino Groups

452 g of example 2.1 and 48 g of water placed in a 11 four-neck flask fitted with blade stirrer, internal thermometer, dropping funnel and reflux condenser. The pH was adjusted to 10 by the addition of 16.8 g NaOH 25%. At room temperature 1.5 g of APK was added and the solution stirred for 1 h at room temperature. The temperature was increased to 70° C. For 6 h this temperature maintained. During the whole reaction period pH was controlled and kept between 9.5 and 10 by adding dropwise 1.3 g of 25% caustic. Finally, the solution was cooled to room temperature and the pH adjusted to 8.5 by addition of HCl 37%.

The product obtained was a clear viscous solution with a solid content of 20.5 and a polymer content of 6.6. 1H-NMR confirmed that the Michael addition was quantitative, because there were no longer olefinic hydrogens visible.

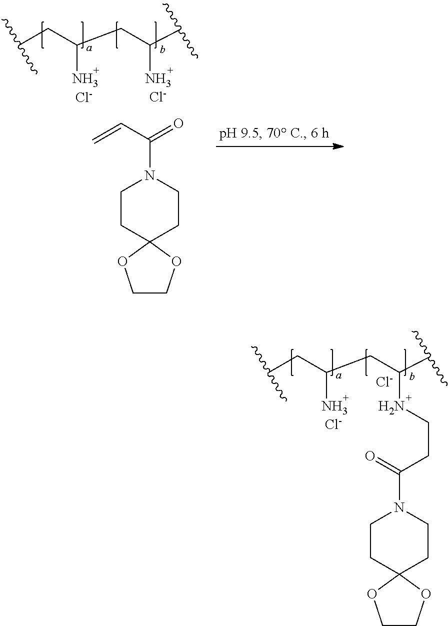

### b) Hydrolysis

150 g of the above Michael addition product were placed in a 500 ml four-neck flask fitted with blade stirrer, internal thermometer, dropping funnel and reflux condenser. f 26.3 g hydrochloric acid, 37% were added and the homogenous solution was heated to 80° C. This temperature was maintained for 4 h. Finally, the product was cooled to room temperature.

The obtained clear solution had a solid content of 17.6% and a pH of 1. 1H-NMR confirmed that the ketal group was fully hydrolysed while HPLC measurements revealed that in this case less than 5% of the piperidone unit was removed from the polymer.

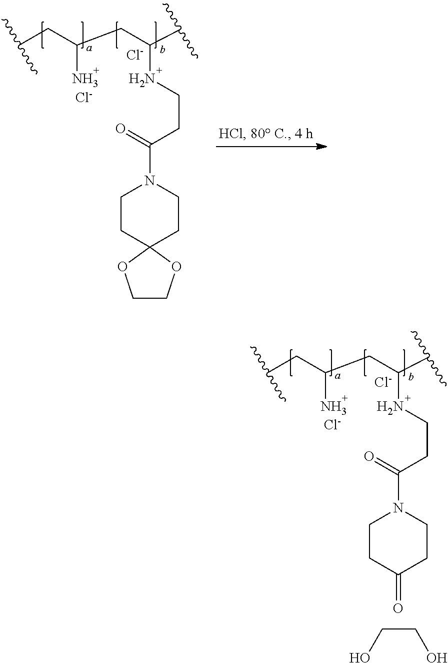

### Comparative Example 2.16-2.18 Trials to Copolymerize VFA and AP

In analogy to the method described in example 2.14 trials were run to co-polymerize VFA and AP. Differing compositions were tested, but all trials resulted in a gelled products.

TABLE 2

| Example | VFA [mol %] | AP [mol %] | |
|---|---|---|---|
| 2.16 | 95 | 5 | Cross-linked during |
| | | | polymerisation |
| 2.17 | 98 | 2 | Cross-linked during |
| | | | polymerisation |
| 2.18 | 99.5 | 0.5 | Cross-linked during |
| | | | post-polymerisation |

Obviously, a co-polymerisation of VFA with AP in an application relevant composition is not feasible.

### Example 2.19 Copolymer VP/APK=99/1 (Molar), Ketal Removed

### a) Polymerization

Feed 1 was provided by dissolving 278.1 g N-vinylpyrrolidon (VP) and 5.5 g of APK (Example 1.4) in 392 g Water

A 2 l glass reactor fitted with anchor stirrer, descending condenser, internal thermometer, nitrogen inlet tube and a septum was initially charged with 230 g water, 22.8 g N-vinylpyrrolidone and 0.4 g APK. While stirring at 150 rpm the initial charge was heated to 87° C. Nitrogen was fed into the solution to remove oxygen. At 87° C. 0.8 g of dimethyl 2,2′-azobis (2-methylpropionate) in 3.7 g ethanol was added via a syringe to start the polymerization. After 10 min feed 1 was started and added within 120 min. While maintain the temperature at 87° C. the following additions of initiator were added over time:

30 min after start 0.4 g dimethyl 2,2′-azobis (2-methylpropionate) in 1.8 g ethanol

60 min after start 0.4 g dimethyl 2,2′-azobis (2-methylpropionate) in 1.8 g ethanol

90 min after start 0.4 g dimethyl 2,2′-azobis (2-methylpropionate) in 1.8 g ethanol

120 min after start 0.2 g dimethyl 2,2′-azobis (2-methylpropionate) in 0.9 g ethanol

After the last addition the reaction mixture was held at 87° C. for another 2 h. The batch was subsequently cooled down to room temperature.

The precursor was a clear nearly colorless, viscous solution having a solids content of 33.1 wt %. The K value of the copolymer was 60 (0.5 wt % in aqueous solution).

### b) Removal of Ketal

150 g of the above precursor were placed in a 500 ml four-neck flask fitted with blade stirrer, internal thermometer, dropping funnel and reflux condenser and heated to 80° C. At a stirrer speed of 80 rpm 0.44 g of 37 wt % hydrochloric acid were added. The mixture was maintained at 80° C. for 4 hours. The product obtained was cooled down to room temperature.

A clear, viscous polymer solution was obtained with a polymer content of 33.0%. According to 1H-NMR the ketal group was fully removed. By means of HPLC measurements the amount of free piperidone hydrochloride in the products were measure which confirmed that less than 0.5% of the piperidone-units were removed from the polymer:

### Example 2.20 Copolymer VP/APK=98.1/1.9 (Molar), Ketal Removed

### a) Polymerization

Feed 1 was provided by dissolving 284.2.1 g N-vinylpyrrolidon (VP) and 10.3 g of APK (Example 1.4) in 392 g Water

A 2 l glass reactor fitted with anchor stirrer, descending condenser, internal thermometer, nitrogen inlet tube and a septum was initially charged with 230 g water, 22.6 g N-vinylpyrrolidone and 0.8 g APK. While stirring at 150 rpm the initial charge was heated to 87° C. Nitrogen was fed into the solution to remove oxygen. At 87° C. 0.8 g of dimethyl 2,2′-azobis (2-methylpropionate) in 3.7 g ethanol was added via a syringe to start the polymerization. After 10 min feed 1 was started and added within 120 min. While maintain the temperature at 87° C. the following additions of initiator were added over time:

30 min after start 0.4 g dimethyl 2,2′-azobis (2-methylpropionate) in 1.8 g ethanol

60 min after start 0.4 g dimethyl 2,2′-azobis (2-methylpropionate) in 1.8 g ethanol

90 min after start 0.4 g dimethyl 2,2′-azobis (2-methylpropionate) in 1.8 g ethanol

120 min after start 0.2 g dimethyl 2,2′-azobis (2-methylpropionate) in 0.9 g ethanol

After the last addition the reaction mixture was held at 87° C. for another 2 h. The batch was subsequently cooled down to room temperature.

The precursor was a clear nearly colorless, viscous solution having a solids content of 33.8 wt %. The K value of the copolymer was 60 (0.5 wt % in aqueous solution).

### b) Removal of Ketal

150 g of the above precursor were placed in a 500 ml four-neck flask fitted with blade stirrer, internal thermometer, dropping funnel and reflux condenser and heated to 80° C. At a stirrer speed of 80 rpm 0.89 g of 37 wt % hydrochloric acid were added. The mixture was maintained at 80° C. for 4 hours. The product obtained was cooled down to room temperature.

A clear, viscous polymer solution was obtained with a polymer content of 33.4%. According to 1H-NMR 97% of the ketal group was removed. By means of HPLC measurements the amount of free piperidone hydrochloride in the products were measure which confirmed that less than 0.5% of the piperidone-units were removed from the polymer.

### Example 2.21 Copolymer VP/APK=95/5 (Molar), Ketal Removed

### a) Polymerization

Feed 1 was provided by dissolving 275.5 g N-vinylpyrrolidon (VP) and 25.7 g of APK (Example 1.4) in 392 g Water

A 2 l glass reactor fitted with anchor stirrer, descending condenser, internal thermometer, nitrogen inlet tube and a septum was initially charged with 230 g water, 21.7 g N-vinylpyrrolidone and 2.1 g APK. While stirring at 150 rpm the initial charge was heated to 87° C. Nitrogen was fed into the solution to remove oxygen. At 87° C. 0.8 g of dimethyl 2,2′-azobis (2-methylpropionate) in 3.7 g ethanol was added via a syringe to start the polymerization. After 10 min feed 1 was started and added within 120 min. While maintain the temperature at 87° C. the following additions of initiator were added over time:

30 min after start 0.4 g dimethyl 2,2′-azobis (2-methylpropionate) in 1.8 g ethanol

60 min after start 0.4 g dimethyl 2,2′-azobis (2-methylpropionate) in 1.8 g ethanol

90 min after start 0.4 g dimethyl 2,2′-azobis (2-methylpropionate) in 1.8 g ethanol

120 min after start 0.2 g dimethyl 2,2′-azobis (2-methylpropionate) in 0.9 g ethanol

After the last addition the reaction mixture was held at 87° C. for another 2 h. The batch was subsequently cooled down to room temperature.

The precursor was a clear nearly colorless, viscous solution having a solids content of 33.8 wt %. The K value of the copolymer was 56 (0.5 wt % in aqueous solution).

### b) Removal of Ketal

150 g of the above precursor were placed in a 500 ml four-neck flask fitted with blade stirrer, internal thermometer, dropping funnel and reflux condenser and heated to 80° C. At a stirrer speed of 80 rpm 2.15 g of 37 wt % hydrochloric acid were added. The mixture was maintained at 80° C. for 4 hours. The product obtained was cooled down to room temperature.

A clear, viscous polymer solution was obtained with a polymer content of 33.1%. According to 1H-NMR 94% of the ketal group was removed. By means of HPLC measurements the amount of free piperidone hydrochloride in the products was measure which confirmed that less than 0.5% of the piperidone-units were removed from the polymer.

### 3. Cross-Linking

### Example 3.1 Cross-Linking of Example 2.1 and OBP

2.0 g of example 2.1 was adjusted with hydrochloric acid to a pH of 7.0

At RT such an amount of OBP was dissolved in 2 ml of water, that the ratio of amino-/keto-groups was 10/1. This solution was added to example 2.1 and mixed in well. The gelated product was stored for 24 h at RT, then washed with acetonitrile and dried.

A solid state 13C-NMR was taken and compared to the one of Example 2.1 and 2 model substances. The comparison confirmed the existence of a cross-linked structure by means of aminal units formed from the keto-groups of OBP.

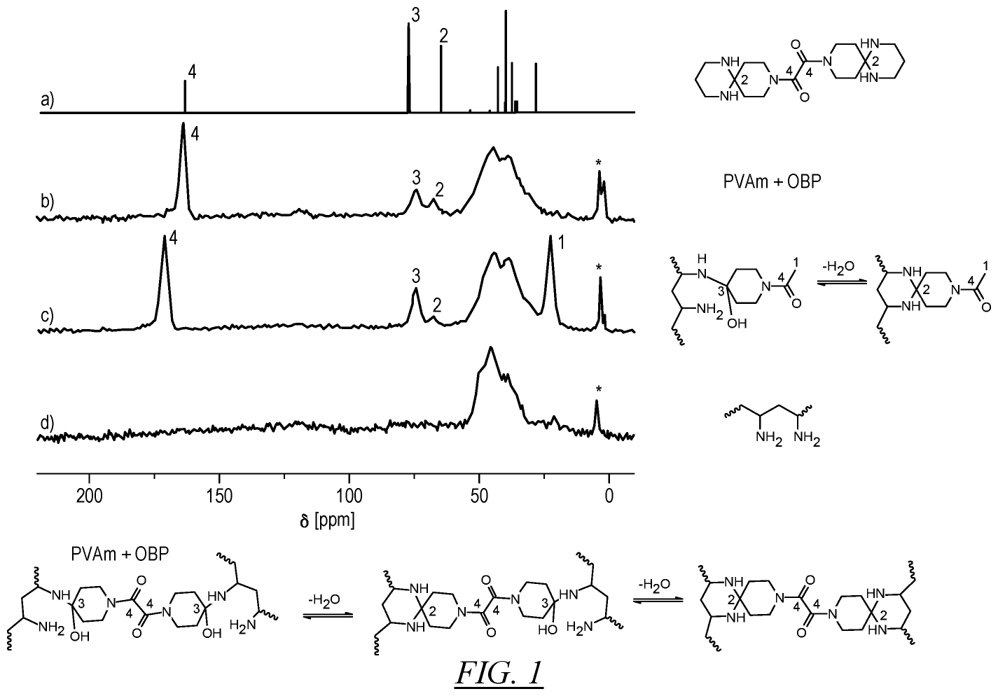

FIG. 1 shows 13C-NMR spectra of model compounds and the cross-linking reaction of OBP and PVAm. a) Model compound from OBP and 1,3-diaminopropane in solvent CDCl₃, b) solid state 13C-NMR spectrum of crosslinked PVAm with OBP, c) solid state 13C-NMR spectrum of PVAm reacted with N-acetylpiperidin-4-one, d) solid state 13C-NMR spectrum of PVAm

### Example 3.2 Cross-Linking of Example 2.1 and TBP

2.0 g of Lupmin 9095 was adjusted with hydrochloric acid to a pH of 7.0

At RT such an amount of TBP was dissolved in 2 ml of water, that the ratio of amino-/keto-groups was 10/1. This solution was added to the Lupamin 9095 and mixed in well. The gelated product was stored for 24 h at RT, then washed with acetonitrile and dried.

A solid state 13C-NMR was taken and compared to the one of Lupamin 9095 and 2 model substances. The comparison confirmed the existence of a cross-linked structure by means of aminal units formed from the keto-groups of TBP.

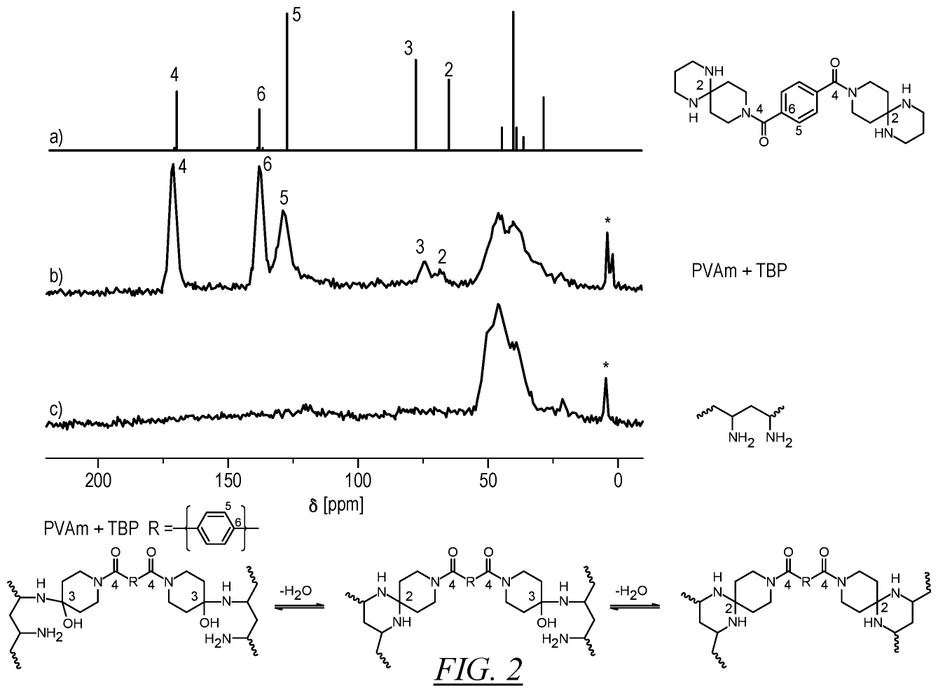

FIG. 2 shows 13C-NMR spectra of model compounds and the cross-linking reaction of TBP and PVAm. a) Model compound from TBP and 1,3-diaminopropane in solvent CDCl₃, b) solid state 13C-NMR spectrum of crosslinked PVAm with TBP, c) solid state 13C-NMR spectrum of PVAm.

### Example 3.3-3.13 Determination of Typical Cross-Linking pH

To investigate the pH-range where cross-linking occurs and to determine the reactivity of the differing polymers the so called “typical cross-linking pH” was determined:

About 20 g of the respective product were placed in a 50 ml 3 necked flask equipped with a mechanical stirrer, dropping funnel and pH-electrode. At room temperature and constant stirring at 250 rpm dropwise 10% NaOH was added while the pH was constantly monitored. The pH were cross-linking occurs (when a gel lump is formed) is the typical cross-linking pH. Cross-linking will occur at all pHs above this value. The lower the typical cross-linking pH is the higher reactive is the sample and the wider is the operational window of the cross-linking system. If the pH is lowered below the typical cross-linking pH the crosslinking is reversible and the gel dissolves again. Results are summarised in the following table:

TABLE 3

| | | | Final | Final |
|---|---|---|---|---|
| | | Start pH | polymer | polymer |
| | Sample | of | VFA | Vinylamine |
| Example | tested | sample | [mol %] | [mol %] |
| 3.3 | 2.5 | 0.3 | 7.6 | 90.9 |
| 3.4 | 2.6 | 1.2 | 35.0 | 63.5 |
| 3.5 | 2.7 | 0.4 | 8.3 | 88.6 |
| 3.6 | 2.8 | 1.6 | 48.7 | 48.3 |
| 3.7 | 2.9 | 0.3 | 0.0 | 94.8 |
| 3.8 | 2.10 | 1.7 | 53.1 | 41.7 |
| 3.9 | 2.11 | 0.0 | 6.1 | 85.2 |
| 3.10 | 2.12 | 1.3 | 48.2 | 43.3 |
| 3.11 | 2.13 | 2.1 | 74.20 | 17.7 |
| 3.12 | 2.14 | 1.5 | 46.4 | 48.4 |
| 3.13 | 2.15 | 1.0 | | 99** |

| | (Final | Final | Critical |
|---|---|---|---|
| | polymer | polymer | cross- |
| | M)APK | Lactam | linking |
| Example | [mol %] | [mol %] | Ph |
| 3.3 | 0.2 | 1.3 | 3.6 |
| 3.4 | 0.4 | 1.1 | 2.5 |
| 3.5 | 0.4 | 2.7 | 3.2 |
| 3.6 | 0.8 | 2.2 | 2.6 |
| 3.7 | 0.3 | 4.9 | 2.3 |
| 3.8 | 1.0 | 4.2 | 2.4 |
| 3.9 | 0.9 | 7.8 | 2.2 |
| 3.10 | 2.3 | 6.2 | 2.2 |
| 3.11 | 6.2 | 1.9 | 3.1 |
| 3.12 | 3.8* | 1.4 | 5.3 |
| 3.13 | 1** | | 1.9 |

*MAPK
**Michael addition product

The inventive polymers do show already at a very low pH—that is at a very low amino-group density and efficient cross-linking.

### Example 3.14-3. Determination of Cross-Linking Time

To investigate the reactivity of cross-linkers in combination with various polymers the so called “cross-linking time” was determined:

About 20 g of the respective product were placed in a 50 ml 3 necked flask equipped with a mechanical stirrer and pH-electrode. The polymer solution was adjusted to a pH 7 by the addition of caustic or hydrochloric acid. At room temperature and constant stirring at 250 rpm the desired amount of cross-linker in form of an aqueous solution was added and the time measured till cross-linking occurred (when a gel lump is formed). The shorter the cross-linking time is the higher is the reactivity of the specific combination of polymer and cross-linker

TABLE 4

| | | | Molar ratio | Cross- |
|---|---|---|---|---|
| | Vinylamine | | cross- | linking |
| | comprising | Cross- | linker/vinylamine | time |
| Examples | polymer | linker | units [mol %] | [sec] |
| 3.14 | 2.1 | 1.1 | 2.0 | 12 |
| | 2.1 | 1.1 | 1.0 | 27 |
| | 2.1 | 1.1 | 0.5 | 43 |
| | 2.2 | 1.1 | 2.0 | 20 |
| | 2.2 | 1.1 | 1.0 | 33 |
| | 2.3 | 1.1 | 2.0 | 50 |
| | 2.3 | 1.1 | 1.0 | 68 |
| | 2.2 | 1.3 | 2.0 | 60 |
| | 2.4 | 1.3 | 2.0 | 50 |
| | 2.1 | 2.21 | 2.0 | 18 |
| | 2.1 | 2.21 | 1.0 | 26 |
| | 2.2 | 2.21 | 2.0 | 22 |
| | 2.2 | 2.21 | 1.0 | 33 |
| | 2.2 | 2.21 | 0.5 | 50 |
| | 2.3 | 2.21 | 2.0 | 60 |
| | 2.3 | 2.21 | 1.0 | 90 |
| | 2.3 | 2.21 | 0.5 | 140 |
| | 2.2 | 2.20 | 2.0 | 29 |
| | 2.2 | 2.20 | 1.0 | 40 |
| | 2.2 | 2.20 | 0.5 | 55 |
| | 2.2 | 2.19 | 2.0 | 50 |
| | 2.2 | 2.19 | 1.0 | 60 |
| | 2.2 | 2.19 | 0.5 | 90 |

### 4. Reversibility of Cross-Linking

### Example 4.1: Reversibility by Means of pH-Change

3.9 g Example 2.1 at 7 pH stained with rhodamine B were crosslinked with 0.075 g OBP dissolved in 1 mL water at RT. The cross-linking reaction produces within a few seconds a solid gel. After adding 2 ml of hydrochloric acid (10 w %) it takes about 2 h till the gel is completely liquefied. When setting the pH back to neutral by adding caustic the gel is instantaneously formed again.

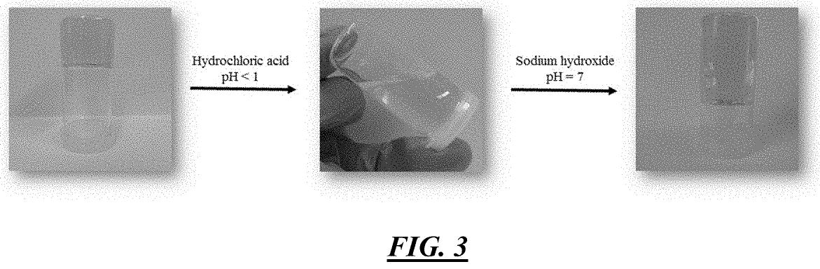

FIG. 3 shows a reversibility experiment of crosslinked polyvinylamine. Addition of hydrochloric acid induces the liquefaction of the gel. Subsequent sodium hydroxide addition leads to gelation

To investigate the chemical process by means of 13C-NMR using N-acetylpiperidin-4-one as model substance:

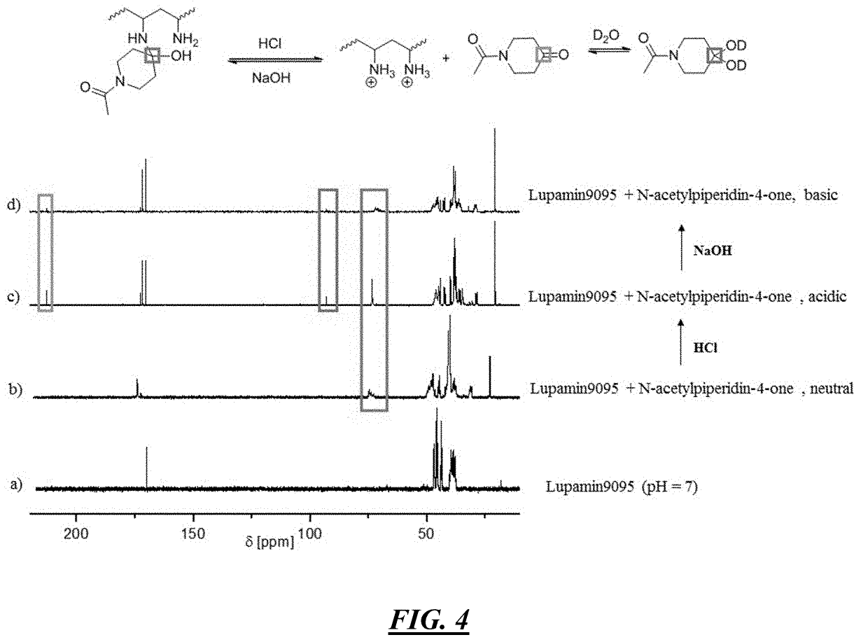

FIG. 4 shows 13C-NMR spectra of example 2.1 reacted with N-acetylpiperidin-4-one at different pHs in water. a) Example 2.1 at pH=7 b) Example 2.1 reacted with N-acetylpiperidin-4-one at pH=7 c) Example 2.1 reacted with N-acetylpiperidin-4-one after addition of hydrochloride acid d) Example 2.1 reacted with N-acetylpiperidin-4-one after addition of sodium hydroxide.

FIG. 4 shows a series of 13C-NMR spectra of example 2.1 reacted with N-acetylpiperidin-4-one. This reaction results in a stable hemiaminals in aqueous solution (see FIG. 4c)). This reaction is reversible. By adding hydrochloric acid, the hemiaminal structure in the equilibrium shifts again to the side of the reactants as seen in FIG. 4b). The 13C-NMR spectrum reveals two additional signals at 212 ppm and 93 ppm, which belong to the carbonyl carbon- and the hydrated carbonyl carbon. Subsequent addition of sodium hydroxide to this mixture shifts the equilibrium back to the hemiaminal structure.

### Example 4.2: Reversibility by Means of Temperature Change

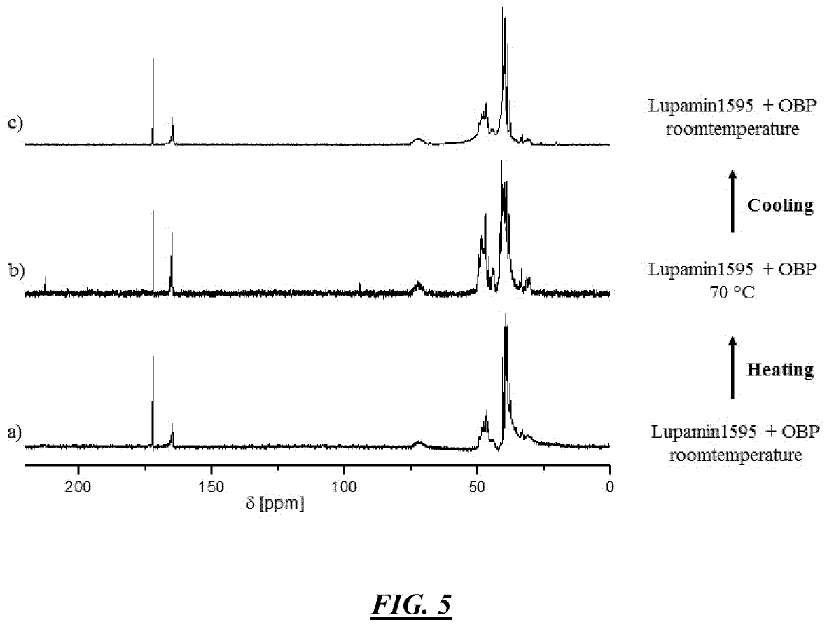

FIG. 5 shows 13C-NMR spectra of example 2.1 crosslinked with OBP in water. a) crosslinked Lupamin9095 at pH=7, room temperature b) crosslinked example 2.1 at pH=7, 70° C. c) crosslinked example 2.1 at pH=7, room temperature after heating.

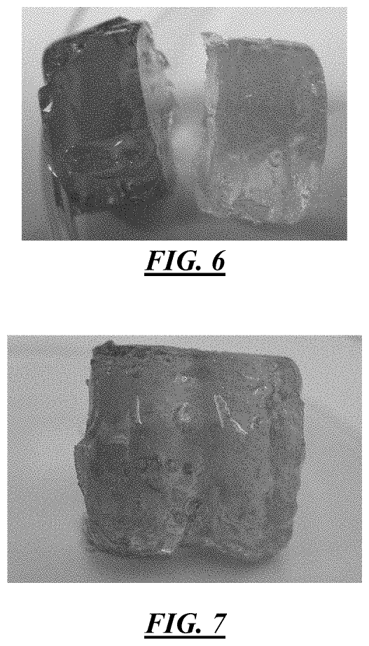

FIG. 5 shows the 13C-NMR spectra of example 2.1 crosslinked with OBP in water. The PVAm gel was prepared in situ in the NMR tube and measured by liquid NMR spectroscopy. At room-temperature only hemiaminal structures were observed (see 5c). Temperature increase of the sample to 70° C. induces a shift of the equilibrium back to reactants as seen in FIG. 6b Signals for the carbonyl carbon and the hydrated carbon can additionally be found. After subsequent cooling to room temperature only hemiaminal structures occur (see 7a)).

### Example 4.3: Self-Healing

FIG. 6 shows polyvinylamine gels crosslinked with OBP and colored with methylene blue and rhodamine B.

Example 2.1 at pH 7 was stained with methylene blue (MB) and then crosslinked with OBP (ratio of primary amino groups NH₂ to carbonyl groups of OBP was 10) using a cylindrical Teflon tube.

An identical sample was synthesized, but instead MB rhodamine B was employed. The two differently colored gels are stacked on top of each other in the cylindrical Teflon tube and heated in a closed system for 3 hours at 70° C. After cooling for one hour, the two pieces of gel have grown together and can no longer be separated from each other (see FIG. 7).

FIG. 7 shows fused polyvinylamine gels.

### 5. Application for Paper Making

### General Procedure for Producing Test Liner Examples 5.3-5.24

Further Compounds Used as Auxiliaries:

Retention Aid: Percol 540 polyacrylamide emulsion having a solids content of 43%, a cationic charge density of 1.7 mmol/100 g and a K value of 240.

### Pretreatment of Paper Stock:

A 100% wastepaper stock (a mixture of the varieties 1.02, 1.04, 4.01) was beaten with tap water in a pulper at a consistency of 4 wt % until free of fiber bundles and ground in a refiner to a freeness of 40° SR. This stuff was subsequently diluted with tap water to a consistency of 0.8 wt %.

The paper stock gave a Schopper-Riegler value of SR 40 in the drainage test.

The wastepaper-based paper stock thus pretreated was admixed under agitation with compositions of examples 5.3-5.24. The aqueous composition was admixed at 0.15 or 0.30 wt % of polymer based on fibrous wastepaper material (solids).

The retention aid (Percol 540) was then added to the paper stock in the form of a 1 wt % aqueous solution meaning that 0.04 wt % of polymer (solids) based on fibrous wastepaper material (solids) was used. The pH of the paper stock was maintained at a constant pH 7

Test papers were then produced using a dynamic sheet-former from Tech Pap, France. The paper was subsequently dried, with contact dryers, to a paper moisture content of 5 wt %.

Reference (not in Accordance with the Present Disclosure)

For reference, the general procedure for producing test liners was followed to produce a paper stock suspension, and sheets of paper therefrom, without adding an inventive aqueous composition.

### Comparative Examples 5.1 and 5.2 (Not in Accordance with the Present Disclosure)

For comparison, the general procedure for producing test liners was followed to produce a paper stock suspension, and sheets of paper therefrom, by using polymer of example 2.2 instead of the inventive composition.

The amount of polymer 2.2 admixed was chosen such that =0.15 or 0.3 wt % of polymer on fibrous wastepaper material (solids) was used.

The papers collated in the Table were subsequently produced.

Performance Testing of Test Papers

The paper was conditioned at 50% relative humidity for 24 hours and then subjected to the following strength tests:
bursting pressure as per DIN ISO 2758 (up to 600 kPa) and DIN ISO 2759 (above 600 kPa)
SCT short span compression test as per DIN 54518 (quantification of strip crush resistance)
CMT corona medium test as per DIN EN 23035 (quantification of flat crush resistance)

TABLE 5

| | | | Basis | | CMT |
|---|---|---|---|---|---|
| | Product | | weight | CMT | Increase |
| Example | tested | Dosage | [g/m2] | [N*m²/g] | [%] |
| Reference | none | | 121.0 | 1.84 | |
| Comparative | 2.2 | 0.15 | 121.4 | 2.33 | 27 |
| 5.1 | | | | | |
| Comparative | 2.2 | 0.30 | 121 | 2.45 | 33 |
| 5.2 | | | | | |
| 5.3 | 2.5 | 0.15 | 122.1 | 2.45 | 33 |
| 5.4 | 2.5 | 0.30 | 121.4 | 2.64 | 43 |
| 5.5 | 2.6 | 0.15 | 122.7 | 2.41 | 31 |
| 5.6 | 2.6 | 0.30 | 122.2 | 2.59 | 41 |
| 5.7 | 2.7 | 0.15 | 121.7 | 2.47 | 34 |
| 5.8 | 2.7 | 0.30 | 121.9 | 2.75 | 50 |
| 5.9 | 2.8 | 0.15 | 121.5 | 2.43 | 32 |
| 5.10 | 2.8 | 0.30 | 121.6 | 2.67 | 45 |
| 5.11 | 2.9 | 0.15 | 122.5 | 2.40 | 31 |
| 5.12 | 2.9 | 0.30 | 122.4 | 2.70 | 47 |
| 5.13 | 2.10 | 0.15 | 122.8 | 2.42 | 32 |
| 5.14 | 2.10 | 0.30 | 122.4 | 2.64 | 43 |
| 5.15 | 2.11 | 0.15 | 122.8 | 2.39 | 30 |
| 5.16 | 2.11 | 0.30 | 122.6 | 2.62 | 42 |
| 5.17 | 2.12 | 0.15 | 122.0 | 2.44 | 33 |
| 5.18 | 2.12 | 0.30 | 122.2 | 2.69 | 46 |
| 5.19 | 2.13 | 0.15 | 121.8 | 2.3 | 25 |
| 5.20 | 2.13 | 0.30 | 121.6 | 2.48 | 35 |
| 5.21 | 2.14 | 0.15 | 121.4 | 2.45 | 33 |
| 5.22 | 2.14 | 0.30 | 121.5 | 2.67 | 45 |
| 5.23 | 2.15 | 0.15 | 122.0 | 2.43 | 32 |
| 5.24 | 2.15 | 0.30 | 121.8 | 2.69 | 46 |

| | | | Burst | Burst |
|---|---|---|---|---|
| | | SCT | Factor | Factor |
| | SCT | Increase | Increase | Increase |
| Example | [kN*m²/g] | [%] | [kPa*m²/g] | [%] |
| Reference | 1.19 | | 2.41 | |
| Comparative | 1.46 | 22 | 2.76 | 14 |
| 5.1 | | | | |
| Comparative | 1.52 | 28 | 3.01 | 25 |
| 5.2 | | | | |
| 5.3 | 1.48 | 25 | 2.92 | 21 |
| 5.4 | 1.64 | 37 | 3.17 | 31 |
| 5.5 | 1.47 | 24 | 2.93 | 21 |
| 5.6 | 1.6 | 34 | 3.13 | 30 |
| 5.7 | 1.54 | 30 | 2.89 | 20 |
| 5.8 | 1.62 | 36 | 3.17 | 32 |
| 5.9 | 1.49 | 25 | 2.96 | 23 |
| 5.10 | 1.62 | 36 | 3.21 | 33 |
| 5.11 | 1.49 | 25 | 2.93 | 22 |
| 5.12 | 1.62 | 36 | 3.18 | 32 |
| 5.13 | 1.47 | 24 | 2.96 | 23 |
| 5.14 | 1.58 | 33 | 3.16 | 31 |
| 5.15 | 1.49 | 25 | 2.82 | 17 |
| 5.16 | 1.65 | 39 | 3.22 | 34 |
| 5.17 | 1.51 | 27 | 2.92 | 21 |
| 5.18 | 1.69 | 42 | 3.28 | 36 |
| 5.19 | 1.44 | 21 | 2.84 | 18 |
| 5.20 | 1.55 | 30 | 3.13 | 30 |
| 5.21 | 1.50 | 26 | 3.04 | 25 |
| 5.22 | 1.62 | 36 | 3.28 | 34 |
| 5.23 | 1.50 | 26 | 2.99 | 24 |
| 5.24 | 1.68 | 41 | 3.28 | 36 |

As is apparent from the results in the above table, using the inventive polymers provides a significant increase in paper strengths.

### Additional Examples

Reversible and Stable Hemiaminal Hydrogels from Highly Reactive Bispiperidone Derivatives and Polyvinylamine

In various embodiments, self-healing and stable hemiaminal hydrogels from polyvinylamine (PVAm) and novel bispiperidone-based ketones are reported. Two highly reactive bisketones undergo fast cross-linking with PVAm in water at room temperature. Detailed NMR spectroscopy reveals an unexpectedly well-defined network chemistry, with cross-links consisting of stable hemiaminals or aminals. Aminals of varying extent only form upon precipitation of gels, at basic pH or for low cross-linking density; other functionalities such as imines are not observed. The dynamic chemistry of this reaction is further investigated by self-healing experiments as well as the temperature- and pH-induced reversibility of model reactions. Rheology confirms an efficient network formation with a high elastic response of up to 15 kPa while exceeding the loss modulus by two magnitudes. The unusually clean and fast reaction to stable hemiaminals, its reversibility as well as the generally lower toxicity of ketones in comparison to commonly used aldehydes, highlight these bispiperidones as highly efficient cross-linking agents and broaden possibilities of dynamic covalent chemistry.

Dynamic covalent polymer chemistry is a field in (bio)polymer and material science with applications in e.g. tissue engineering, drug delivery and recyclable polymers. Likewise, cross-linking polymers is a key step e.g. to render polymer thin films insoluble, for nanoparticle formation, designing network topologies and to tune mechanical properties. Among suitable functional groups and substrates enabling dynamic reactions, amines and aldehydes such as glyoxal or glutaraldehyde are typical examples. Similarly, formaldehyde is a well-known, established electrophile for condensation networks that has recently been used in recyclable thermosets. However, the toxicity of formaldehyde, glyoxal, glutaraldehyde and aldehydes in general, is a major drawback. Consequently, replacing aldehydes by ketones is desirable, but the lower reactivity of the latter has restricted their use as cross-linkers and in dynamic covalent chemistry for water-borne systems. To make this reaction amenable yet, either reactivity of the nucleophile or of the electrophile needs to be increased. To this end, acylhydrazines and most recently triketones appear promising, but are only available at increased synthetic cost. Another obstacle of carbonyl/amine systems is that a mix of reaction products with heterogeneous properties and unknown structure-function relationships is often obtained. Polyvinylamine (PVAm) is a simple, yet highly functionalized and water-soluble polymer known for e.g. papermaking, waste water treatment, and super absorber materials. Next to electrostatic interactions of charged, polycationic PVAm with surfaces or physical cross-linkers, PVAm undergoes a number of nucleophilic substitution reactions with epoxides, aldehydes, isocyanates, or electron-deficient aromatics. Ketones are generally less electrophilic than aldehydes and do not react with amines in water, with PVAm being an exception. Notably, the use of PVAm for dynamic network formation remains unexplored.

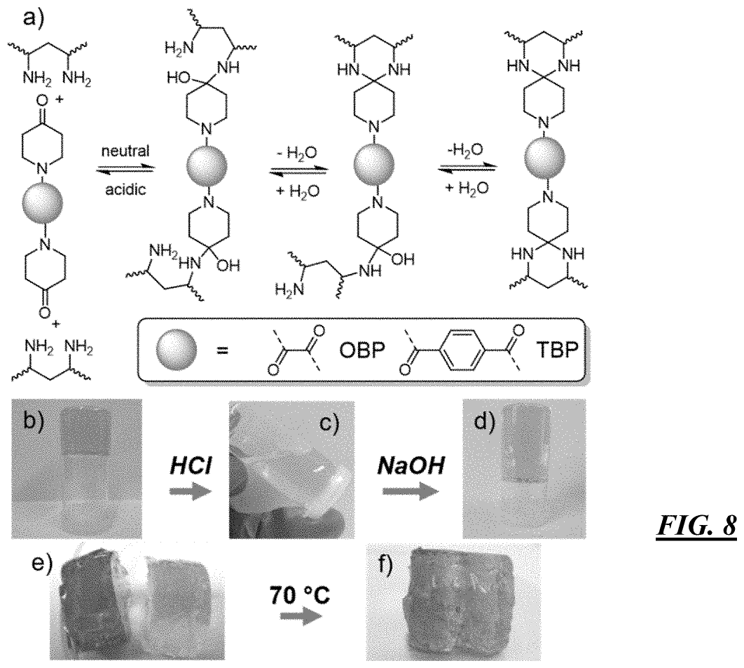

Below are described two water-soluble and highly reactive piperidone-based bisketones as simple, efficient yet reversible cross-linking agents for PVAm in water (FIG. 8).

FIG. 8 shows a) Cross-linking polyvinylamine (PVAm) with bispiperidone derivatives in water. OBP: oxalyl-bispiperidinone, TBP: terephthalyl-bis-piperidinone. The reaction is pH-dependent, with cross-linking occurring at neutral to basic pH and the back reaction being promoted under acidic conditions. b) gelated PVAm with OBP, c) acidified PVAm gel, d) re-gelated PVAm gel, e), f) temperature-induced joining of two gels. Samples in b)-f) are colored for better visibility.

Detailed ¹³C NMR spectroscopy experiments reveal that the resulting hydrogels exhibit an unprecedented clean chemistry characterized by surprisingly stable, yet dynamic hemiaminal cross-links with a variable content of aminal functionalities. Detailed model reactions, and temperature-, pH- and stoichiometry-dependent experiments suggest that the hemiaminal network is enabled and stabilized by i) the high reactivity of the bisketone, ii) the presence of water, iii) acidic to neutral pH and iv) for a certain range of amine/ketone ratios (cross-linking density). Finally, rheological measurements confirm the network formation and the self-healing capability of the system.

The reaction scheme 1a of FIG. 8 shows the chemical structures of PVAm, the two cross-linkers 1,2-bis(4-oxo-piperidin-1-yl)ethane-1,2-dione (OBP) and 1,1′-terephthaloylbis(piperidin-4-one) (TBP), and possible cross-links found for varying conditions. The reaction of the hemiaminal to the aminal occurs via the corresponding imine. However, imines are not observed spectroscopically and hence are excluded from this scheme 1a. The two novel cross-linkers OBP and TBP were prepared from the corresponding diacid chlorides and piperidone in 63 and 52% isolated yield, respectively, and showed water solubilities of 60 and 0.5 mg/mL, respectively (see Supporting Information). OBP with significantly higher water solubility was used for hydrogel formation and to investigate its chemistry with PVAm in detail (hydrogel formation of PVAm and TBP occurred in a similar fashion). The addition of 1-5 mol-% OBP to an aqueous solution of PVAm (Scheme 1b of FIG. 8) led to instantaneous gelation of the mixture, indicating a fast reaction. The addition of HCl liquefied the mixture (Scheme 1c of FIG. 8). Subsequent addition of aqueous NaOH led to re-gelation (Scheme 1d of FIG. 8). Casted and cut gels exhibited self-healing behavior after heating to 70° C. following cooling (Schemes 1e and 1f of FIG. 8). Due to fast gelation and the low concentration of cross-linker, the self-healing properties apparently stem from temperature-induced dynamic chemistry rather than from an initially incomplete cross-linking reaction.

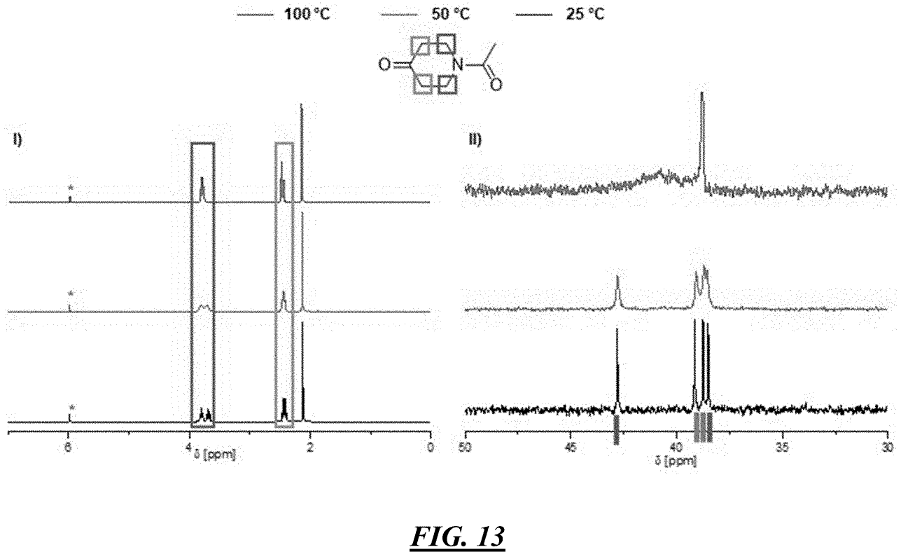

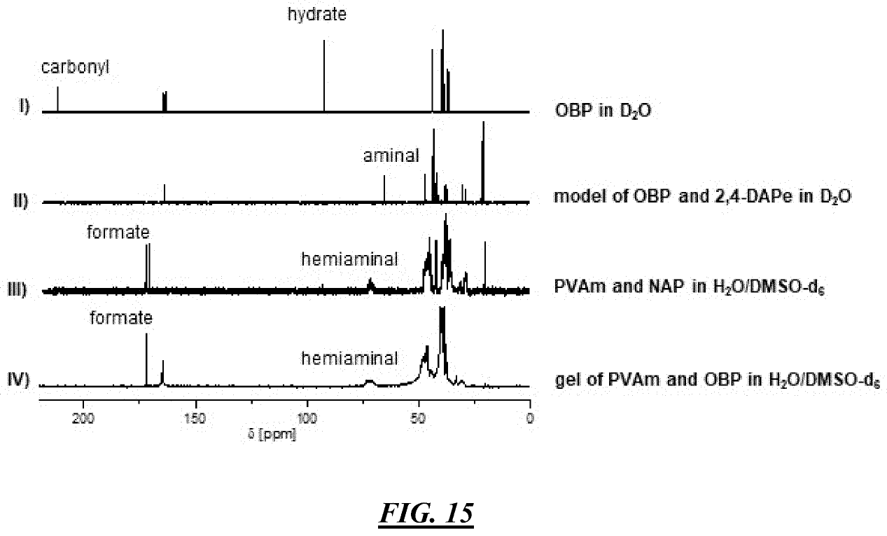

To investigate the underlying chemistry of network formation, NMR spectroscopy of solutions, gels and solids was employed in detail, and model reactions with diamines and the monofunctional ketone N-acetylpiperidin-4-one (NAP) were performed. 1,3-Diaminopropane (DAPr) and racemic 2,4-diaminopentane (DAPe) react with NAP and OBP in methylene chloride quantitatively to give the corresponding aminals. In water at pH=7, a reaction does not take place. These reactions were followed by ¹³C NMR spectroscopy, and assignments were used to investigate PVAm chemistry (see Supporting Information FIGS. 13-23). At neutral pH, PVAm reacts with NAP to give hemiaminals exclusively (FIG. 15). The same reaction was performed with PVAm and OBP, and the resulting hydrogels were investigated by ¹³C NMR spectroscopy in the gel state (FIG. 15). At neutral pH, hemiaminals are seen exclusively. The gels were further precipitated and the resulting solids were investigated by solid state NMR spectroscopy.

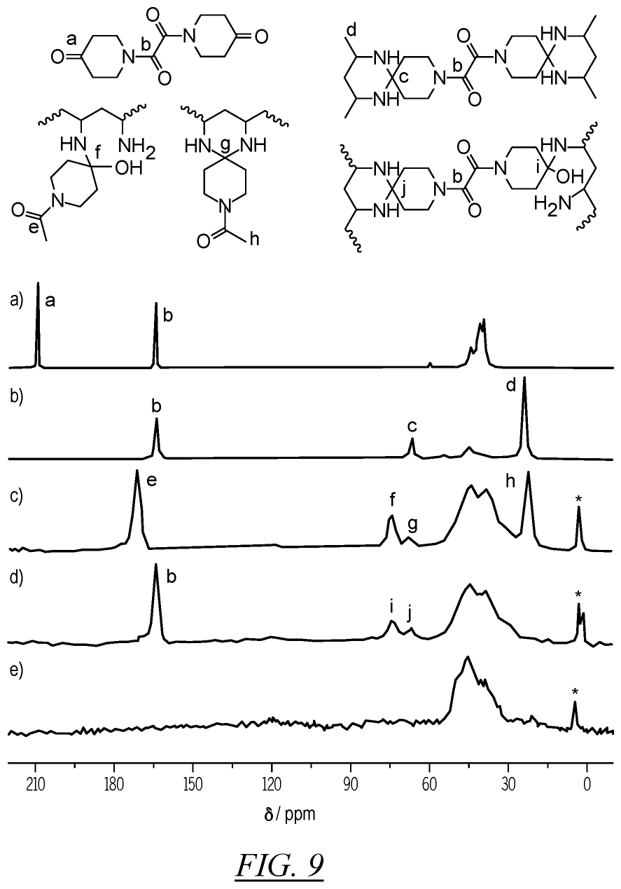

FIG. 9 shows representative solid state ¹³C NMR spectra of a) OBP, b) its model compound with DAPe, c) PVAm and NAP, d) PVAm and OBP and e) PVAm. Aided by the assignments of chemical shifts of OBP and DAPe in solution (FIG. 15, 16) determination of the network structure in the solid state was straightforward (FIG. 9a,b). The spectra of the model compound (FIG. 9b), the product of PVAm with NAP (FIG. 9c) and with OBP (FIG. 9d) did not show residual carbonyl resonances indicating complete consumption of the ketone. Instead, the precipitated hydrogel exhibited two characteristic new signals at 67 ppm (minor) and 75 ppm (major), which were, by comparison with the chemical shifts of the aminals in solution and solid state, assigned to hemiaminal and aminal cross-links, respectively (FIG. 9d). Further corroboration of this non-trivial assignment comes from what follows.

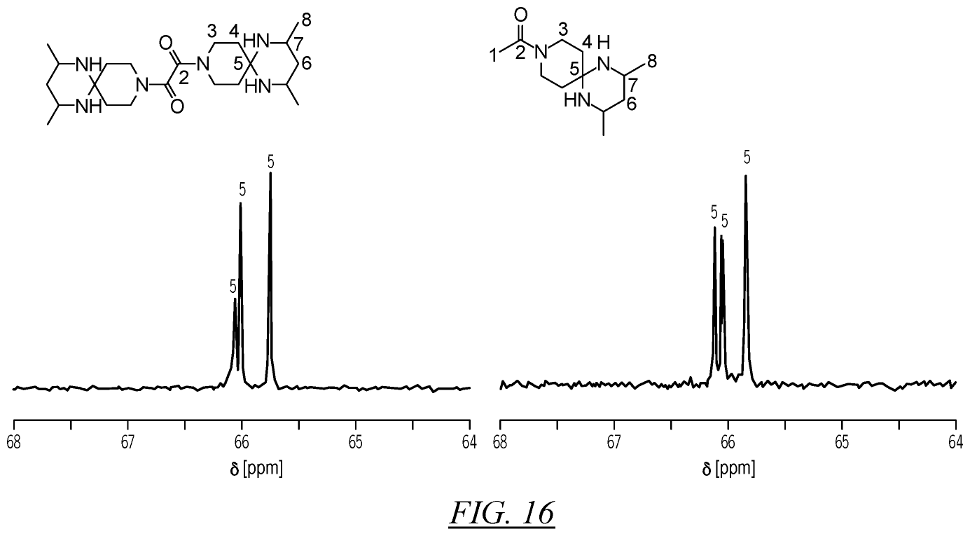

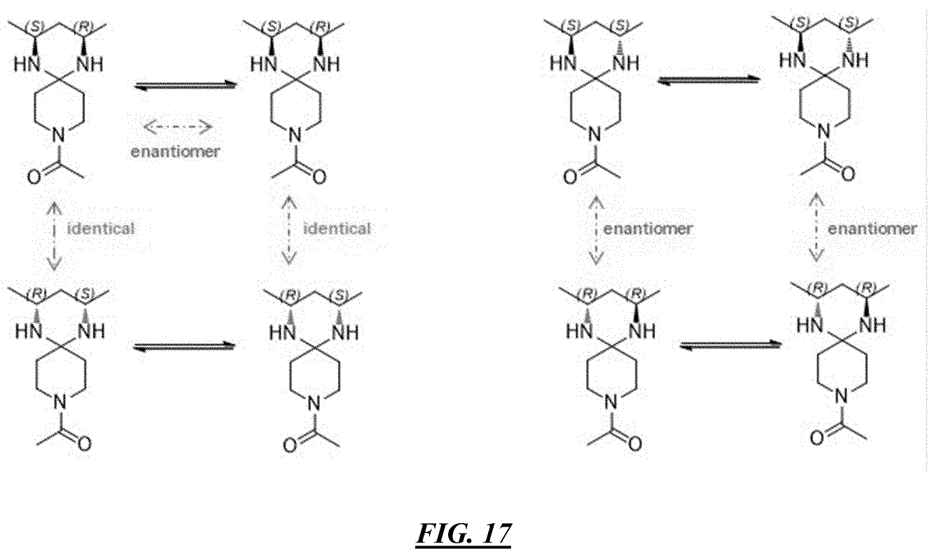

First, the possibility was excluded that these two signals were caused by the two possible meso (m) and racemic (r) dyads of atactic PVAm, leading to different aminal stereoisomers. This can be seen by the model compound from DAPe and NAP showing different resonances of the aminal carbons between 65.8 and 66.1 ppm. These are ascribed to the m- and r-stereoisomers (FIGS. 16, 17). This chemical shift range is much smaller compared to the observed difference between signals f/g and i/j in FIG. 1c,d of ˜8 ppm. Imine formation shown by chemical shifts of the involved carbons at 165 ppm is not found.

FIG. 9 shows a solid-state ¹³C NMR spectra of solids/precipitated gels: a) OBP, b) the model compound with rac-2,4-diaminopentane, c) PVAm and N-acetylpiperidin-4-one, d) PVAm and OBP and e) PVAm. * marks acetonitrile which was used to precipitate the gels. Note that the mixed hemiaminal/aminal chemical structure of d) is just one possibility with the two symmetric ones omitted.

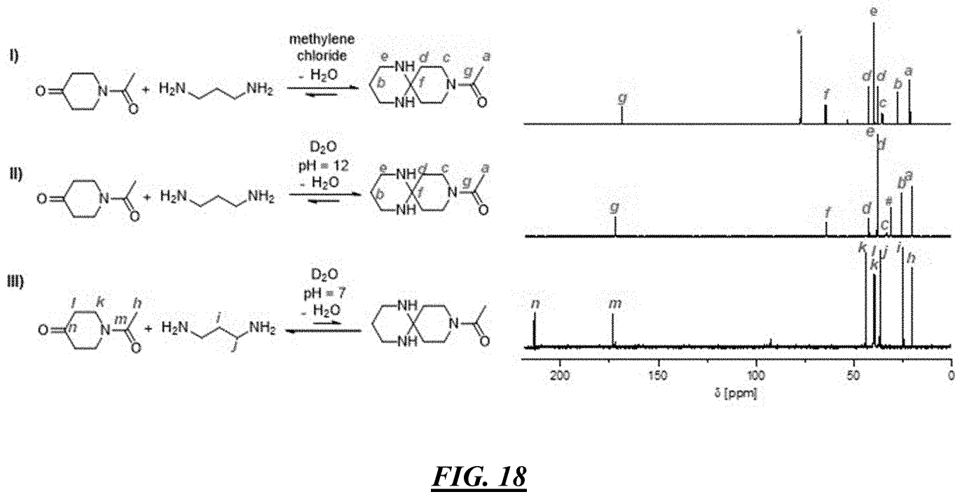

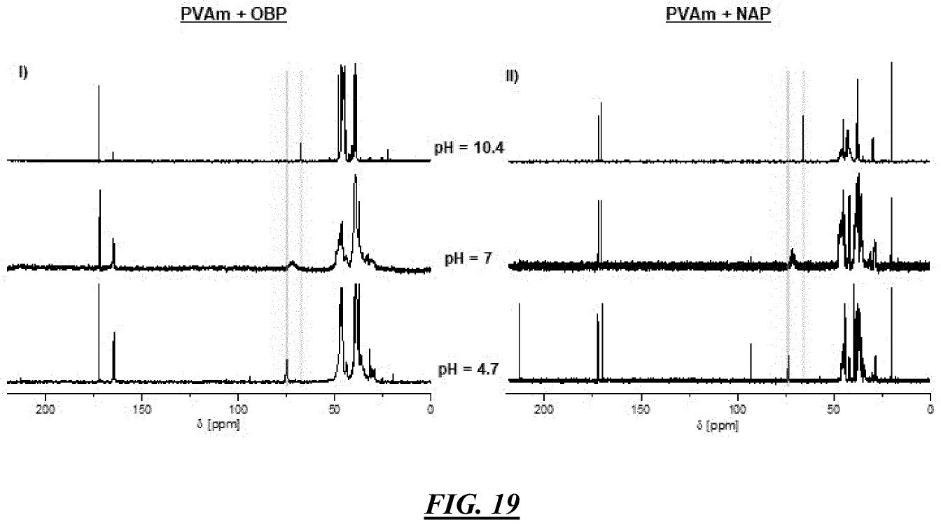

Additionally, the unusual observation of rather stable hemiaminals, and varying hemiaminal/aminal ratios under different conditions, was further investigated by water content-, pH-, stoichiometry- and temperature-dependent experiments. While PVAm and OBP in the gel state showed hemiaminal cross links exclusively (FIG. 15), precipitation of the gels into acetonitrile led to a minor content of aminal functionalities (FIG. 9d). Obviously, removing water shifts the equilibrium shown in Scheme 1a to the right side. Due to the basicity of amines, approx. 70% of —NH₂ functionalities of PVAm are protonated at pH=7. Clearly, this is a prime factor for aminal formation. The higher degree of ionization of simple amines further provides an explanation for NAP or OBP being unreactive towards DAPr and DAPe at neutral pH, while at pH=12 the aminal is furnished quantitatively (FIG. 18). To investigate the effect of pH on network structure, PVAm solutions were adjusted to different pH, cross-linked with OBP and precipitated. FIG. 2 shows the resulting solid state NMR spectra as a function of the initial pH of the PVAm solution. Exclusive hemiaminal and aminal formation occurs pH 4.7 and 10.4, respectively, and intermediate ratios are found in between. The increasing degree of ionization of PVAm with decreasing pH explains well the increasing hemiaminal content (see also FIG. 19 for solution and gel ¹³C NMR spectra). On this basis, the pH-dependent reversible gelation shown in Scheme 1 can be understood as well.

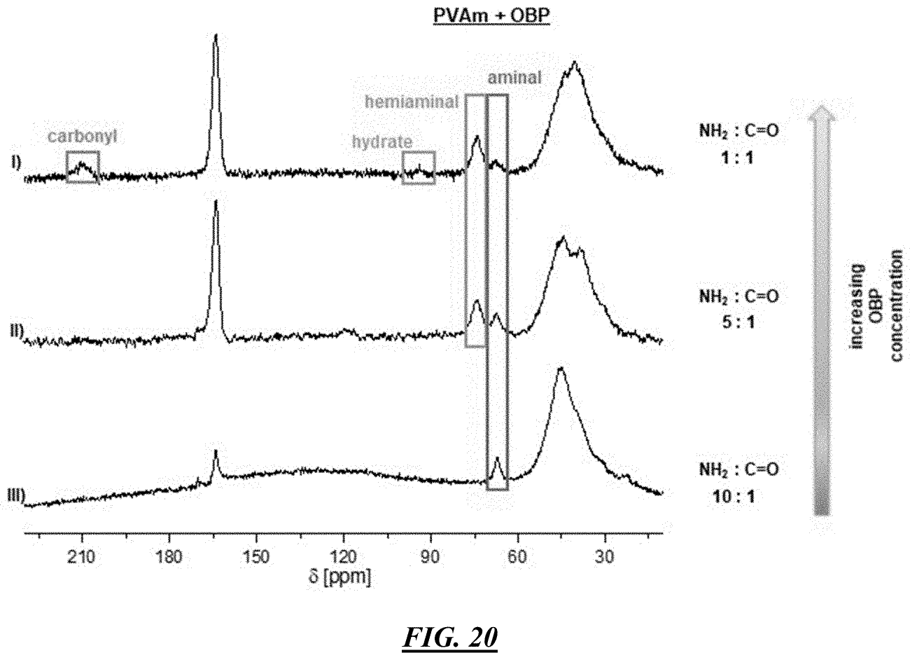

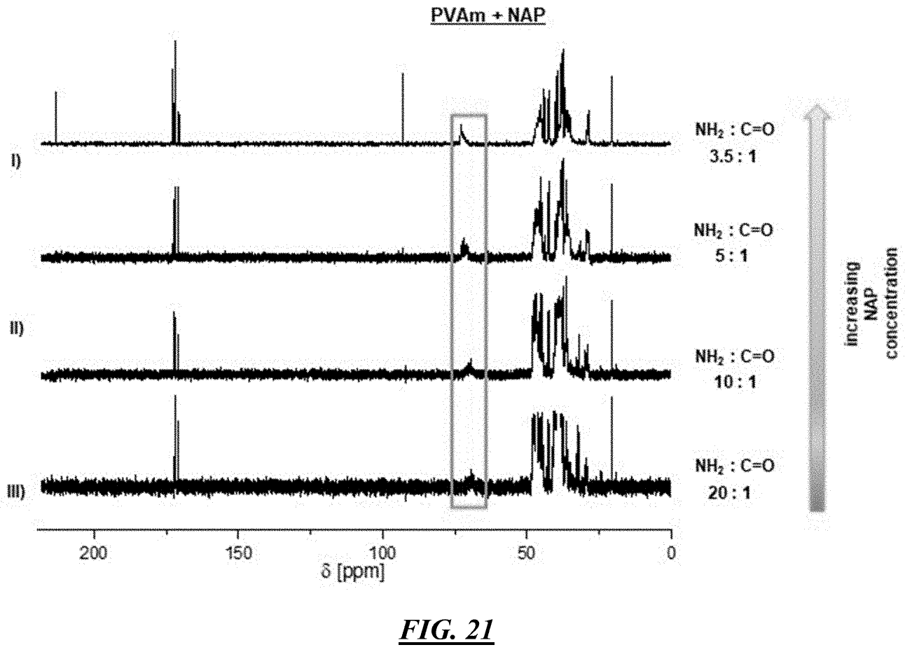

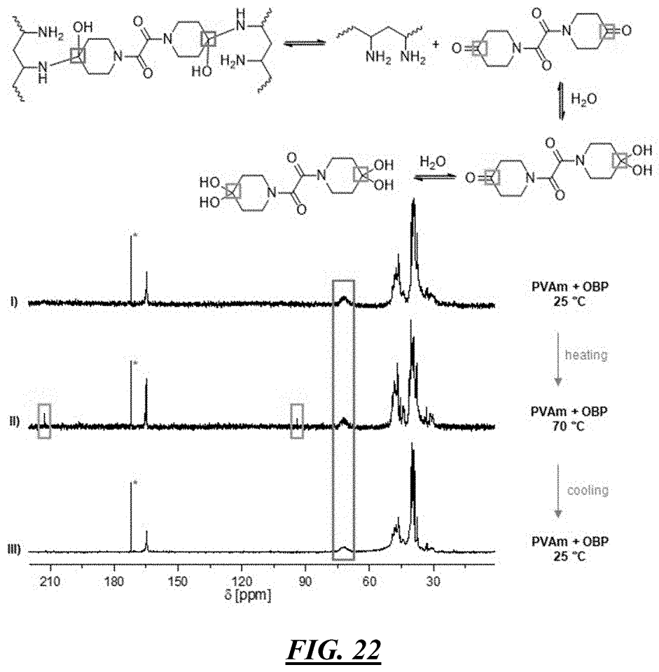

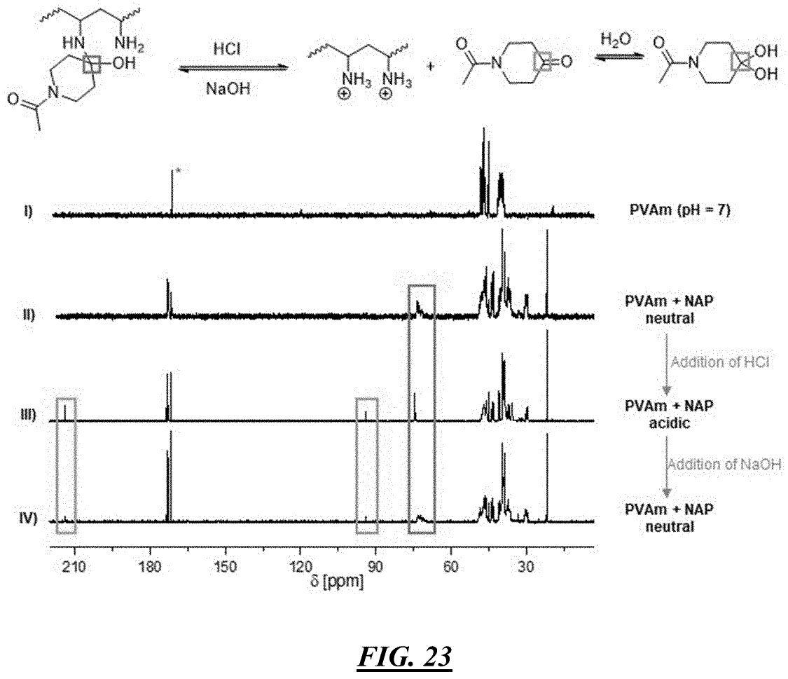

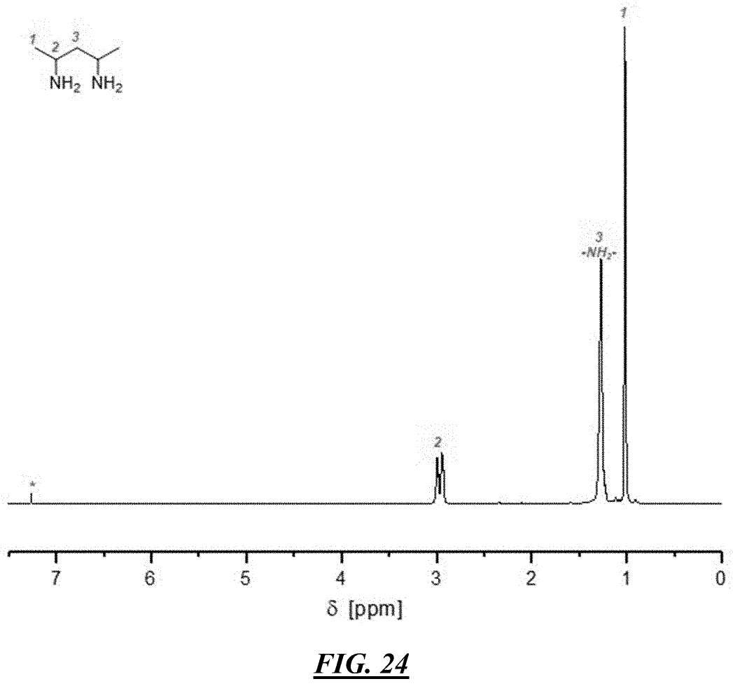

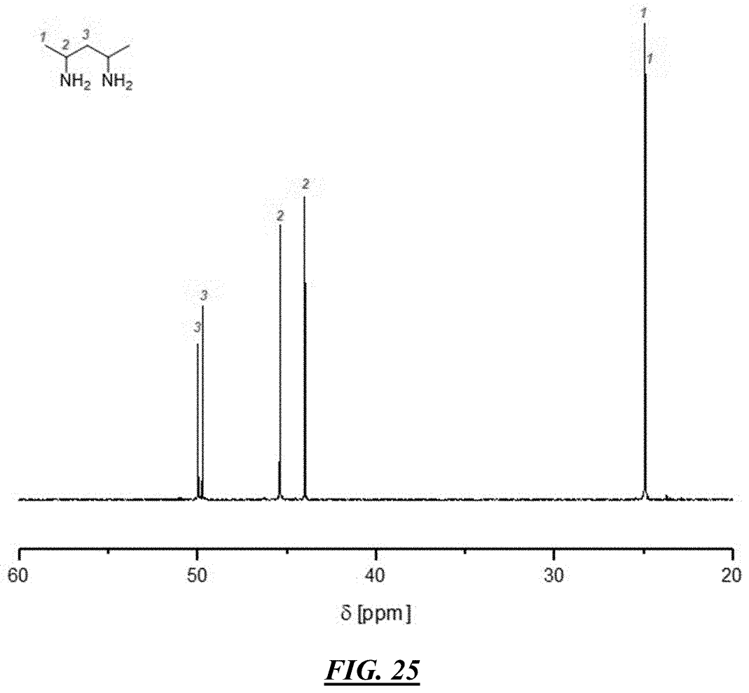

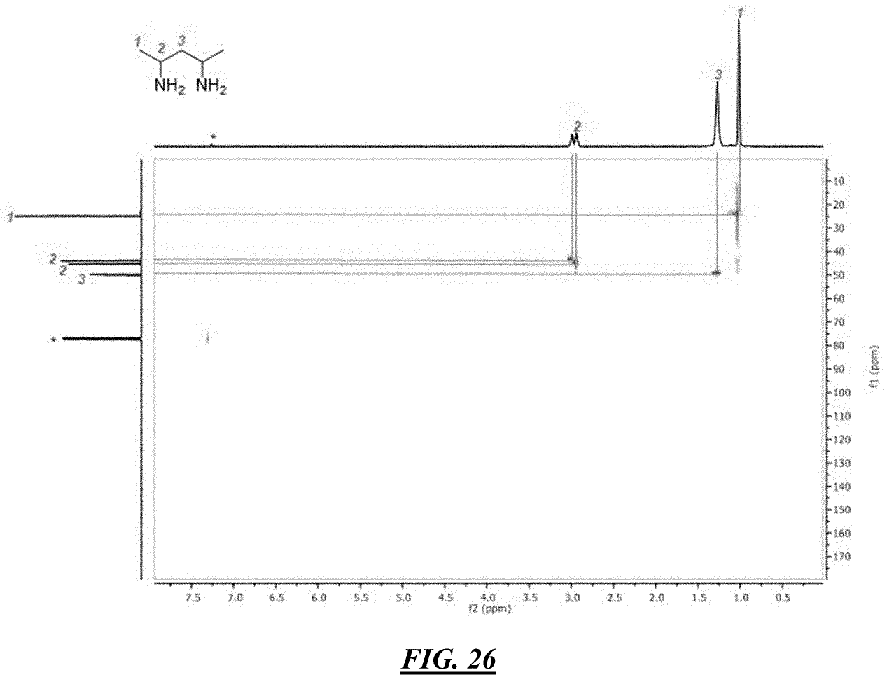

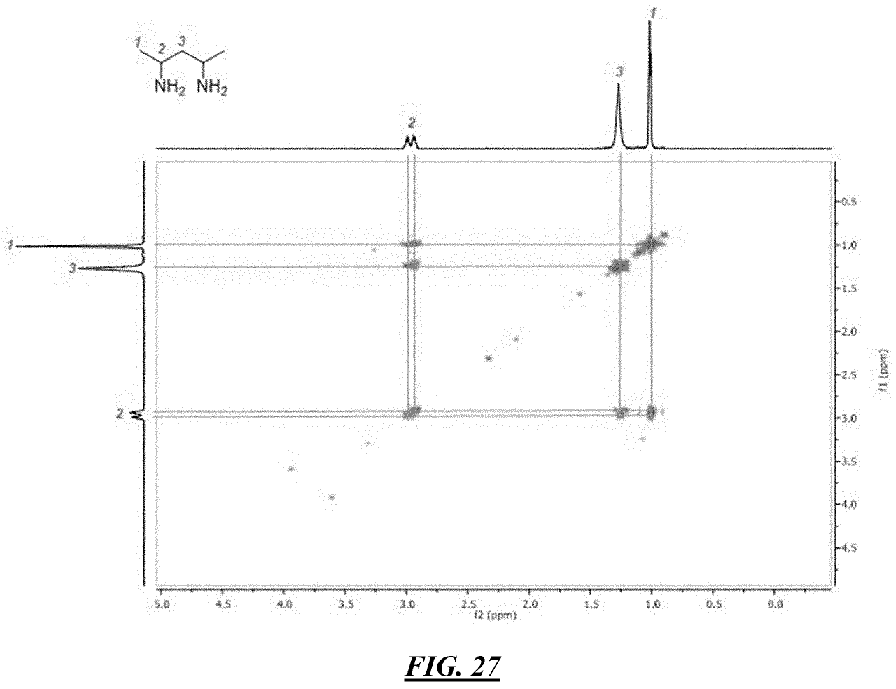

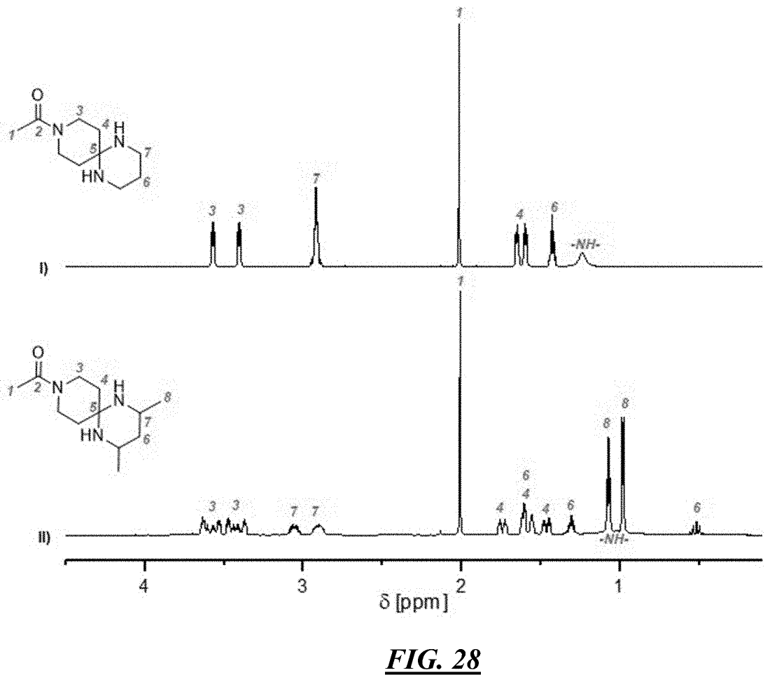

Amine/ketone stoichiometry was further found to strongly influence hemiaminal content. At pH 7, precipitated gels exhibited exclusive aminal cross-links for ratios amine/ketone ≥10, and mixed hemiaminal/aminal products for smaller values (FIGS. 20, 21). Finally, the effect of temperature was elucidated. ¹³C NMR spectra were taken of the PVAm/OBP system in D₂O, at pH 7 and for a ratio of amine/carbonyl of 5. While at room temperature complete conversion of OBP to the hemiaminal was found, its carbonyl resonance reappeared at 70° C. (FIG. 22). A similar behavior is found when the pH is varied (FIG. 23). This back reaction also explains the temperature- and pH-induced self-healing behavior.

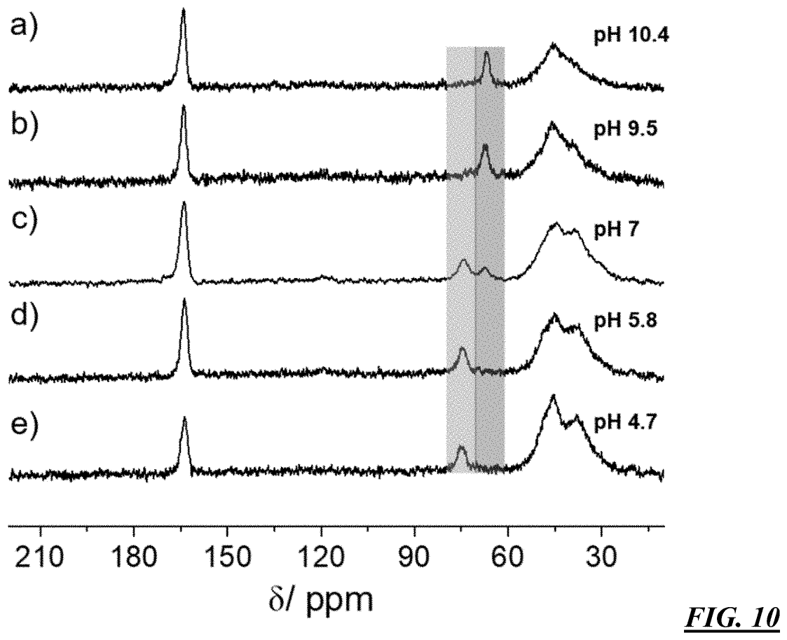

FIG. 10 shows solid state ¹³C NMR spectra of precipitated gels of PVAm cross-linked with OBP. PVAm solutions were adjusted to different pH, cross-linked and precipitated.

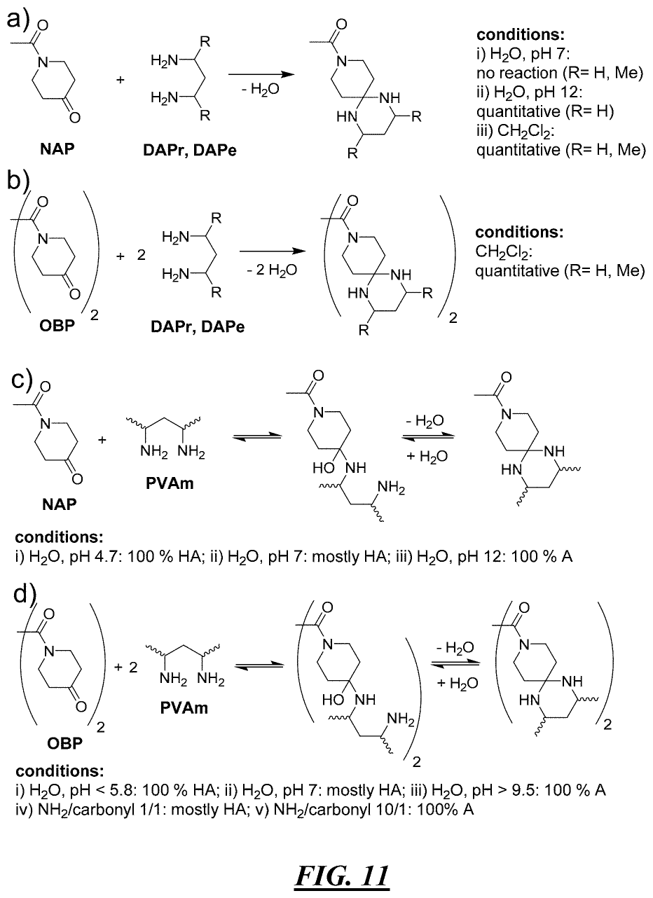

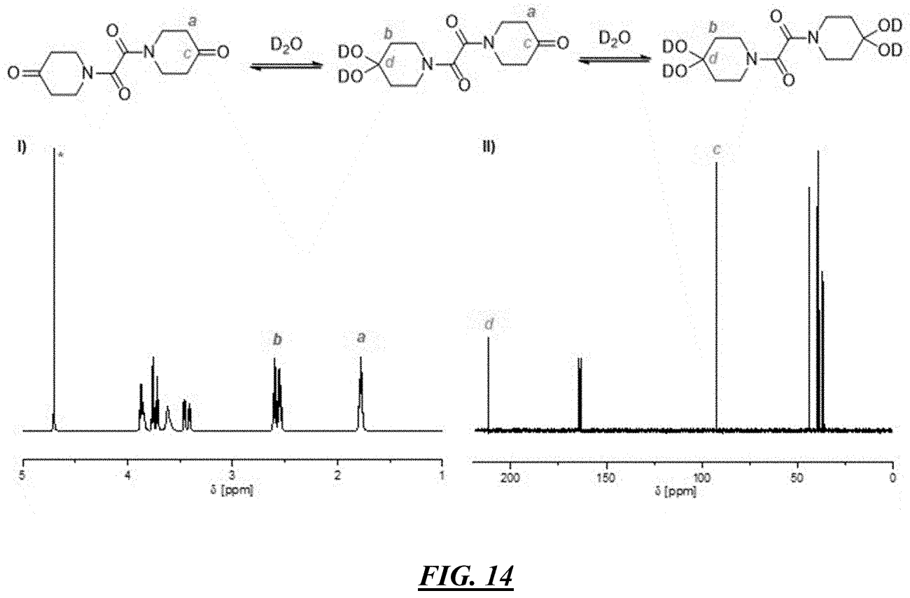

Despite the various factors influencing hemiaminal stability and hemiaminal/aminal ratio such as water content, pH, stoichiometry and temperature, the prevalence of hemiaminal cross-links is unusual and must be enabled by additional enthalpic contributions. As hemiaminals from primary amines and ketones are commonly unstable and react further to give imines and aminals, we envisioned electronic effects to play a role as well. Stabilization of hemiaminals is known to require electron withdrawing groups or hydrogen bonding. Here, we argue that the bisamide core of OBP increases electrophilicity of the ketone leading to the generally observed high reactivity of OBP towards amines. In addition, OBP forms its organic hydrate in water (FIG. 14), which lowers the concentration of the ketone form available for cross-linking and is further proof for the observed high reactivity. Another factor is related to the special structure of PVAm, which may stabilize the hemiaminal further by hydrogen bonding to neighboring amine or ammonium groups. This typical mechanistic aspect requires clarification and is subject to further investigations. Thus, we conclude that OBP is highly reactive towards amines in organic solvents, but shows a diverse reactivity in water under varying conditions, especially with PVAm. The main results of this diverse reactivity are summarized in FIG. 11.

FIG. 11 sets forth a summary of the most typical reactions of a,c) NAP and b,d) OBP with amines to explain the chemistry of PVAm. HA and A denotes hemiaminal and aminal, respectively.

To investigate the mechanical properties of the hydrogel and to confirm the formation of cross-linking points from a mechanical point of view, dynamic rheological measurements were performed. Hydrogel samples with a varying degree of cross-linking (DC=n(OBP)/n(Am) [mol %]) in the range of 1-5 mol % and a water content of 94 wt % were analyzed under oscillatory shear. FIG. 3a shows the elastic (G′) and viscous (G″) moduli as a function of the frequency (f). All samples show an elastic response over the entire frequency range, with G′ distinctly exceeding G″ by two magnitudes. Additionally, a frequency independent behavior for G′ is observed.

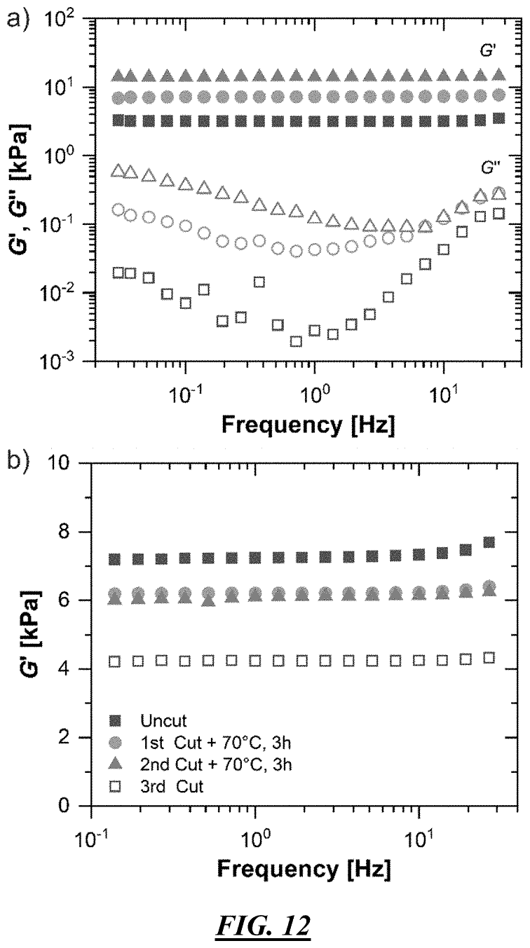

FIG. 12 shows Oscillatory shear rheology of PVAm hydrogels cross-linked with OBP with varying degrees of cross-linking (1, 3 and 5 mol %) and a water content of 94 wt %. a) Frequency sweeps at a constant strain of γ₀=0.1% show an elastic response. b) Measurements of the self-healing capabilities for the sample with DC=3 mol %, which is repeatedly cut and cured at 70° C. for 3 h.

The loss factor (tan δ=G″/G′), which is used as a measure to quantify the extent of viscous contribution in the material, is found to be between 0.001 and 0.01 at a frequency of 1 Hz, further confirming the gel-like character. As expected, a linear dependency and an increase of mechanical strength up to 15 kPa at higher DC values is observed. As a proof of concept for the self-healing capabilities, the sample with DC=3 mol % is repeatedly cut and cured at 70° C. for 3 h in a sealed environment. Oscillatory shear measurements are performed to track macroscopic changes of the specimen for each step, as depicted in FIG. 3b. In the first self-healing cycle a decrease of the storage modulus by 14% from approximately 7 kPa to 6 kPa is found, which however stays constant for the subsequent cycle. As a reference, the specimen was cut and measured directly without curing where a significant decrease of G′ by 42% is observed. Hence, the minor changes of mechanical moduli after curing at elevated temperatures further suggests a dynamic network formation. All mentioned factors obtained from the rheological behavior indicate the formation of a hydrogel and the use of OBP as an efficient cross-linking agent for PVAm solutions despite having a high water content of 94 wt %.

In summary, highly reactive bispiperidone crosslinkers that form hemiaminal hydrogels with aqueous solutions of polyvinylamine instantaneously have been developed. The resulting networks are characterized by an unprecedented clean and reversible chemistry and mostly consist of hemiaminals. Aminals are, however, also found depending on conditions. This amine/ketone chemistry to be highly suitable for dynamic covalent chemistry with many possibilities for reversible polymerizations and networks, which is the subject of ongoing investigations.

### Experimental Section

Hydrogels were prepared by adding aqueous OBP solution to aqueous PVAm solution. Solid networks were prepared by precipitating the hydrogels into acetonitrile followed by drying under air and room temperature. Rheological measurements were performed on the strain-controlled rotational rheometer Ares G2 (TA Instruments, Eschborn, Germany. All other experimental procedures are described herein.

### Content

1. Synthesis and Instrumentation

2. Synthesis and 1H and 13C NMR characterization of OBP and TBP

3. Synthesis and 1H and 13C NMR data of model compounds

4. Temperature-dependent NMR measurements of 1-acetylpiperidin-4-one

5. Behavior of the crosslinker OBP in water

6. 13C NMR spectra of piperidone derivatives in solution (D2O) and in the gel state

7. Stereoisomers resulting from reaction of DAPe and NAP

8. Reaction of NAP with DAPr under different conditions

9. Effect of pH on the reaction of PVAm with ketones

10. Effect of crosslinking density

11. Reversibility of the piperidone-PVAm reaction

### 1. Synthesis and Instrumentation

### 1.1. Synthesis and Hydrogel Preparation

Materials. All substrates and materials were used as received from commercial suppliers, unless otherwise stated. N-acetylpiperidin-4-one (NAP) was purchased from J&K Scientific (97%). 2,4-diaminopentane (DAPe) was purchased from Akos.

Lupamin9095 was used in the experiments performed unless otherwise stated. Desalted aqueous solutions of PVAm were obtained from BASF with the commercial name Lupamin9095 (containing 6.6 w % PVAm, Mw: 340000 g/mol) and Lupamin1595 (containing 7.7 w % PVAm, Mw: <10000 g/mol), pH was adjusted by adding hydrochloric acid.

General procedure for hydrogel preparation. First, the pH of 3.3 g of a Lupamin9095 solution was adjusted with hydrochloric acid to 7. Then, a defined amount of piperidone derivative dissolved in 2.5 mL water was added. The ratio of amino to keto group usually was 5:1 (—NH₂: C═O) unless otherwise noted. In the case of gelation, the product was allowed to stand for 24 hours, otherwise it was stirred for 24 hours. Solids for solid state NMR were isolated by precipitation or washing in acetonitrile followed by drying in air.

### 1.2. Instrumentation

NMR spectra were recorded with an AVANCE NEO 600 FT spectrometer (Bruker Corp., Billerica, Mass.) operating at 600 MHz for ¹H NMR and 151 MHz for ¹³C NMR. ¹H NMR and ¹³C NMR signals were referenced with the help of the residual solvent signals and recalculated relative to the TMS standard. A Bruker Fourier 300HD spectrometer and a Bruker DRX 250 spectrometer were used for long term ¹³C NMR experiments at elevated temperatures (¹³C: 75 MHz and 62.5 MHz).

Solid state NMR measurements were performed at 9.4 T on a Bruker Avance 400 spectrometer equipped with double-tuned probes capable of MAS (magic angle spinning). The samples were packed in 3.2 mm rotors (OD) made of zirconium oxide spinning at 15 kHz. ¹H-MAS NMR was obtained with single puls excitation (90° puls, puls length 2.4 μs) and a recycle delay of 8 s. ¹³C-{¹H}-CP-MAS NMR spectra were acquired using cross polarization (CP) technique with contact time of 3 ms to enhance sensitivity, a recycle delay of 6 s and ¹H decoupling using a TPPM (two puls phase modulation) puls sequence. The spectra are referenced with respect to tetramethyl silane (TMS) using TTSS (tetrakis(trimethylsilyl)silane) as a secondary standard (3.55 ppm for ¹³C, 0.27 ppm for ¹H).

Quantitative elemental analyses were performed on a Vario Micro Tube from Elementaranalysensysteme GMBH Hanau.

pH values were determined using a pH electrode from Vario.

Rheological properties of the hydrogels were analyzed via oscillatory shear experiments on the strain-controlled rotational rheometer Ares G2 (TA Instruments, Eschborn, Germany). Hydrogel samples with a varying degree of cross-linking (DC) between 1 and 5 mol % (DC=n(OBP)/n(Am) [mol %]) were prepared in a cylindrical PTFE mold with a diameter of ˜30 mm to obtain uniform disc-shaped specimens. The cross-linking agent (OBP) was first dissolved in 1 ml H₂O and then mixed with 3 ml of the 6.6 wt % PVAm solution. The mold was sealed and the cross-linking reaction was allowed to proceed overnight.

The test geometry was a 30 mm diameter plate made from aluminum. The geometry was lowered until a constant axial force of 0.5 N was applied to the sample and the temperature was controlled to 25±0.1° C. by a Peltier element (Advanced Peltier System, TA Instruments). First, an oscillatory strain sweep was performed with a constant frequency of f=1 Hz by varying the strain from γ₀=0.01-1000% to determine the linear viscoelastic (LVE) regime. The values at a strain of γ₀=0.1% were chosen to be representative for the LVE regime. Subsequently, frequency sweeps were employed at a fixed strain of 0.1% while the frequency was varied from 0.03 to 100 Hz. To study the self-healing properties, the sample with DC=3 mol % was cut and subsequently cured in a sealed mold at 70° C. for 3 h.

2. Synthesis and ¹H and ¹³C NMR Characterization of OBP and TBP

OBP and TBP were synthesized in two steps. First, 4-piperidone monohydrate hydrochloride was converted to 4-piperidone. In the second step, 4-piperidone was reacted with the respective diacid chloride derivative.

### 2.1. Synthesis of 4-Piperidone

4-Piperidone monohydrate hydrochloride (7.7 g, 0.05 mol) and K2CO3 (9.6 g, 0.05 mol) were dissolved in 30 ml water and stirred for 30 minutes. The free base was extracted by liquid-liquid extraction with dichloromethane (DCM) by means of a perforator for 24 h at 65° C. The organic phase was dried with MgSO₄, filtered and the solvent evaporated under reduced pressure.

4-Piperidone was obtained as yellow solid in 93% yield.

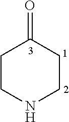

1H NMR (CDCl3, 600 MHz, δ [ppm]): 1.90 (1H, NH), 2.34-2.48 (t, 4H, H-1), 3.08-3.20 (t, 4H, H-2).

13C NMR (CDCl3, 600 MHz, δ [ppm]): 43.7 (C-1), 47.3 (C-2), 209.2 (C-3).

### 2.2. Syntheses of OBP and TBP

4-Piperidone (4.6 g, 0.047 mol), K₂CO₃ (12.4 g, 0.09 mol) and 250 ml dried dichloromethane were stirred in a three-necked 500 mL flask under argon. 0.024 mol of the corresponding dichloride (OBP: oxalylchloride, TBP: terephtaloylchloride) were added dropwise while cooling the mixture with an ice bath. The reaction mixture was stirred for 24 h at room temperature, filtered and the filtrate was washed with aqueous NaHCO₃. The organic phase was dried with MgSO₄, filtered, and the solvent evaporated under reduced pressure. The products were obtained as white solids.

### OBP:

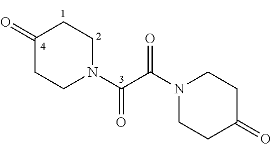 [SMILES: O=C1CCN(C(=O)C(=O)N2CCC(=O)CC2)CC1]

Yield 63%, mp: 174° C.

¹H NMR (CDCl3): 2.50 (t, 4H, H-1), 2.53 (t, 4H, H-1), 3.67 (t, 4H, H-2), 3.87 (t, 4H, H-2).

13C NMR (CDCl3): 40.5 (C-2), 40.6 (C-1), 41.3 (C-1), 45.1 (C-2), 162.8 (C-3), 205.4 (C-4)

Anal. calcd. for C12H16N2O4: C: 57.13H: 6.39 N: 11.10 found: C: 56.73H: 6.33 N: 10.86.

TBP:

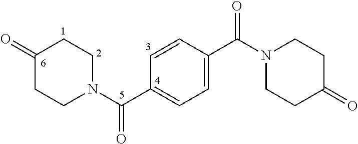 [SMILES: O=C1CCN(C(=O)c2ccc(C(=O)N3CCC(=O)CC3)cc2)CC1]

Yield 52%, mp: 265° C.

1H NMR (CDCl3, 600 MHz, δ [ppm]): 2.36-2.54 (8H, H-1), 3.66-3.97 (8H, H-2), 7.79 (s, 4H, H-3).

13C NMR (CDCl3, 600 MHz, δ [ppm]): 40.8 (C-1), 41.3 (C-1), 41.6 (C-2), 46.3 (C-2), 127.3 (C-3), 137.0 (C-4), 169.6 (C-5), 206.3 (C-6).

Anal. calcd. for C18H20N2O4: C: 65.84H: 6.14 N: 8.53 found: C: 64.80H: 6.04 N: 8.29.

3. Synthesis and ¹H and ¹³C NMR Data of Model Compounds

General procedure: 1 mmol diamine was dissolved in 5 mL dried dichloromethane and 0.5 mmol diketone was added (for NAP 1 mmol). The reaction mixture was stirred for 24 h. After removal of the solvent the obtained product was analyzed via NMR spectroscopy.

### 3.1 Reaction of NAP and DAPr

### 1-(1,5,9-Triazaspiro[5.5]undecan-9-yl)ethanone

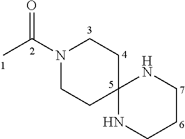

Yield 98%

1H NMR (CDCl3, 600 MHz, δ [ppm]): 1.33 (2H, —NH—), 1.43 (m, 2H, H-6), 1.60 (t, 2H, H-4), 1.66 (t, 2H, H-4), 2.02 (s, 3H, H-1), 2.91 (4H, H-7), 3.40 (t, 2H, H-3), 3.58 (t, 2H, H-3).

13C NMR (CDCl3, 600 MHz, δ [ppm]): 21.4 (C-1), 27.9 (C-6), 35.5 (C-4), 35.9 (C-4), 37.8 (C-3), 39.6 (C-7), 42.7 (C-3), 64.5 (C-5), 168.6 (C-2).

### 3.2 Reaction of OBP and DAPr

### 1,2-Bis(1,5,9-triazaspiro[5.5]undecan-9-yl)ethane-1,2-dione

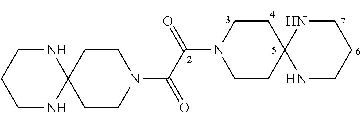 [SMILES: O=C(C(=O)N1CCC2(CC1)NCCCN2)N1CCC2(CC1)NCCCN2]

Yield 97%

1H NMR (CDCl3, 600 MHz, δ [ppm]): 1.18 (4H, —NH—), 1.42 (m, 4H, H-6), 1.66 (8H, H-4), 2.91 (8H, H-7), 3.34 (t, 4H, H-3), 3.60 (t, 4H, H-3).

13C NMR (CDCl3, 600 MHz, δ [ppm]): 28.0 (C-6), 35.2 (C-4), 35.9 (C-4), 37.2 (C-3), 39.6 (C-7), 42.7 (C-3), 64.6 (C-5), 163.3 (C2).

### 3.3 Reaction of NAP and DAPe

### 1-(2,4-Dimethyl-1,5,9-triazaspiro[5.5]undecan-9-yl)ethanone

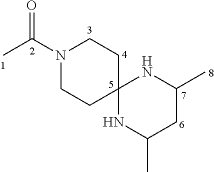 [SMILES: CC(=O)N1CCC2(CC1)NC(C)CC(C)N2]

Yield 99%

1H NMR (CDCl3, 600 MHz, δ [ppm]): 0.51 (H-6), 0.98 (H-8), 1.07 (H-8), 0.77-1.20 (—NH—), 1.30 (H-6), 1.44 (H-4), 1.48 (H-4), 1.55 (H-4), 1.60 (H-4, H-6), 1.72 (H-4), 1.75 (H-4), 2.0 (H-1), 2.83-2.96 (H-7), 3.00-3.12 (H-7), 3.33-3.50 (H-3), 3.52-3.64 (H-3).

13C NMR (CDCl3, 600 MHz, δ [ppm]): 21.4 (C-1), 23.1 (C-8), 23.2 (C-8), 31.8 (C-4), 32.6 (C-4), 37.7 (C-3), 38.2 (C-3), 38.3 (C-4), 38.4 (C-3), 38.9 (C-4), 40.4 (C-4), 40.6 (C-6), 41.3 (C-4), 42.6 (C-3), 42.8 (C-7), 43.1 (C-3), 43.3 (C-3), 43.9 (C-4 or C-6), 44.0 (C-6), 44.6 (C-7), 44.8 (C-7), 65.7 (C-5), 65.9 (C-5), 66.0 (C-5), 168.7 (C-2).

### 3.4 Reaction of OBP and DAPe

### 1,2-Bis(2,4-dimethyl-1,5,9-triazaspiro[5.5]undecan-9-yl)ethane-1,2-dione

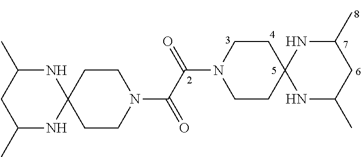 [SMILES: CC1CC(C)NC2(CCN(C(=O)C(=O)N3CCC4(CC3)NC(C)CC(C)N4)CC2)N1]

Yield 99%

1H NMR (CDCl3, 600 MHz, δ [ppm]): 0.50 (H-6), 0.97 (H-8), 1.06 (H-8), 0.69-1.25 (—NH—), 1.30 (H-6), 1.50 (H-4), 1.62 (H-4, H-6), 1.77 (H-4), 2.85-2.91 (H-7), 3.01-3.09 (H-7), 3.30-3.41 (H-3), 3.57-3.68 (H-3).

13C NMR (CDCl3, 600 MHz, δ [ppm]): 23.1 (C-8), 23.2 (C-8), 31.6 (C-4), 32.6 (C-4), 37.0 (C-3), 37.5 (C-3), 37.7 (C-3), 38.2 (C-4), 38.9 (C-4), 40.1 (C-4), 40.5 (C-6), 41.1 (C-4), 42.4 (C-3), 42.5 (C-7), 42.9 (C-7), 43.0 (C-3), 43.2 (C-3), 43.9 (C-6), 44.6 (C-7), 44.7 (C-7), 65.8 (C-5), 66.0 (C-5), 66.1 (C-5), 163.2-163.4 (C-2).

### 3.5 Reaction of TBP and DAPr

### 1,4-Phenylene-bis(1,5,9-triazaspiro[5.5]undecan-9-yl-methanone)

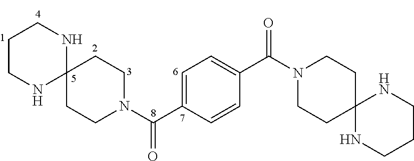 [SMILES: O=C(c1ccc(C(=O)N2CCC3(CC2)NCCCN3)cc1)N1CCC2(CC1)NCCCN2]

Yield 96%

1H NMR (CDCl3, 600 MHz, δ [ppm]): 1.19 (4H, —NH—), 1.39 (4H, H-1), 1.56 (4H, H-2), 1.57 (4H, H-2), 2.91 (8H, H-4), 3.34 (4H, H-3), 3.73 (4H, H-3), 7.33 (s, 4H, H-6).

13C NMR (CDCl3, 600 MHz, δ [ppm]): 28.0 (C-1), 35.6 (C-2), 35.8 (C-2), 38.4 (C-3), 39.6 (C-4), 43.8 (C-3), 64.5 (C-5), 126.8 (C-6), 137.4 (C-7), 168.9 (C-8).

4. Temperature-Dependent NMR Measurements of 1-acetylpiperidin-4-One

The piperidone derivative shows five different ¹³C NMR signals for the six membered ring at room temperature. Also the ¹H NMR spectra show more signals than expected because of the partial double bond character of the amide bond. At room temperature, free rotation is prevented so all ring carbons have a different chemical environment. The measurement at 100° C. shows only one set of signals for all carbons indicating that the coalescence temperature of the N—CO-bond is lower than 100° C.

FIG. 13 shows regions of ¹H-NMR (I) and ¹³C-NMR (II) spectra of variable temperature NMR measurements of N-acetylpiperidin-4-one (NAP) in tetrachloroethane-d₂ (*) @Bruker DRX 250.

### 5. Behavior of the Crosslinker OBP in Water

Crosslinking reactions of PVAm with OBP take place in water. Therefore, the reaction between OBP and water was studied. As expected, in water, dynamic equilibria between the diketone, the mono-ketone and the bis-diol are found.

FIG. 14 includes ¹H— and ¹³C NMR spectra of OBP in D₂O (*) @Bruker Avance Neo 600.

6. ¹³C NMR Spectra of Piperidone Derivatives in Solution (D₂O) and in the Gel State

FIG. 15 includes ¹³C NMR spectra of piperidone derivatives in solution (D₂O) and in the gel state @ Bruker Avance Neo 600 (I, II, III) and @Bruker Fourier 300HD

FIG. 15 shows ¹³C NMR of I) OBP in D₂O, II) the model compound synthesized from OBP and DAPe in methylene chloride and measured in D₂O and III) PVAm crosslinked with OBP and measured in the gel state. For the gel measurement the aqueous PVAm solution tuned to pH 7 was placed in a NMR tube. A few drops of DMSO-d₆ were added to enable the deuterium lock necessary for high resolution NMR measurements. An aqueous solution of OBP was then added rapidly and gel formation was observed. The obtained gel was examined by NMR spectroscopy.

7. Stereoisomers Resulting from Reaction of DAPe and NAP

FIG. 16. Sections of the ¹³C NMR spectra of I) 1,2-bis(2,4-dimethyl-1,5,9-triazaspiro[5.5]undecan-9-yl)ethane-1,2-dione and II) 1-(2,4-dimethyl-1,5,9-triazaspiro[5.5]undecan-9-yl)ethanone in the range from 37 to 46 ppm measured in CDCl₃ @Bruker Avance Neo 600.

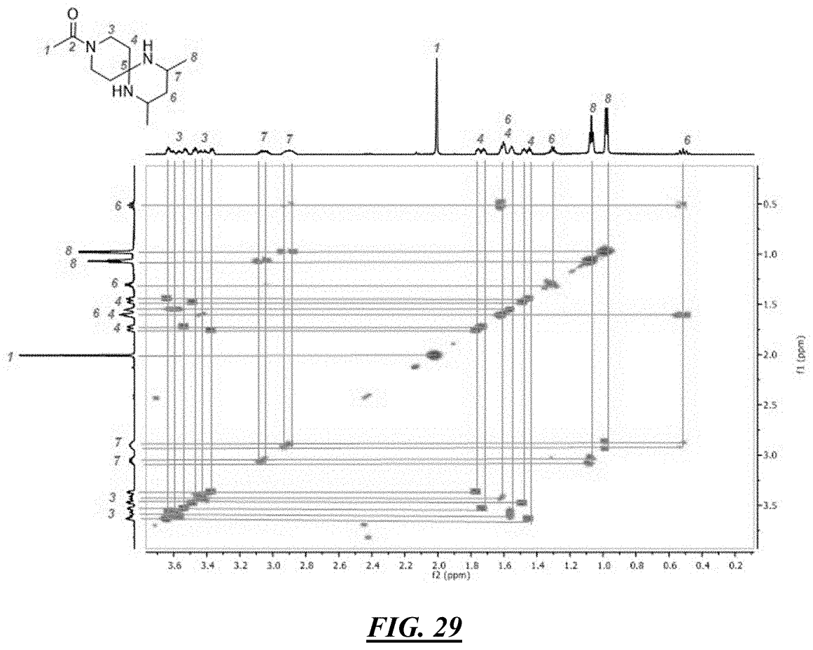

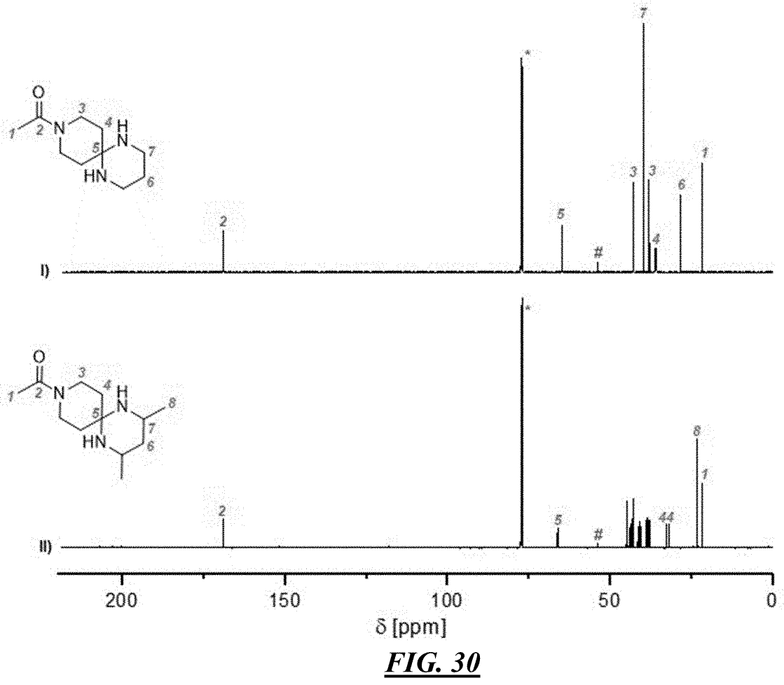

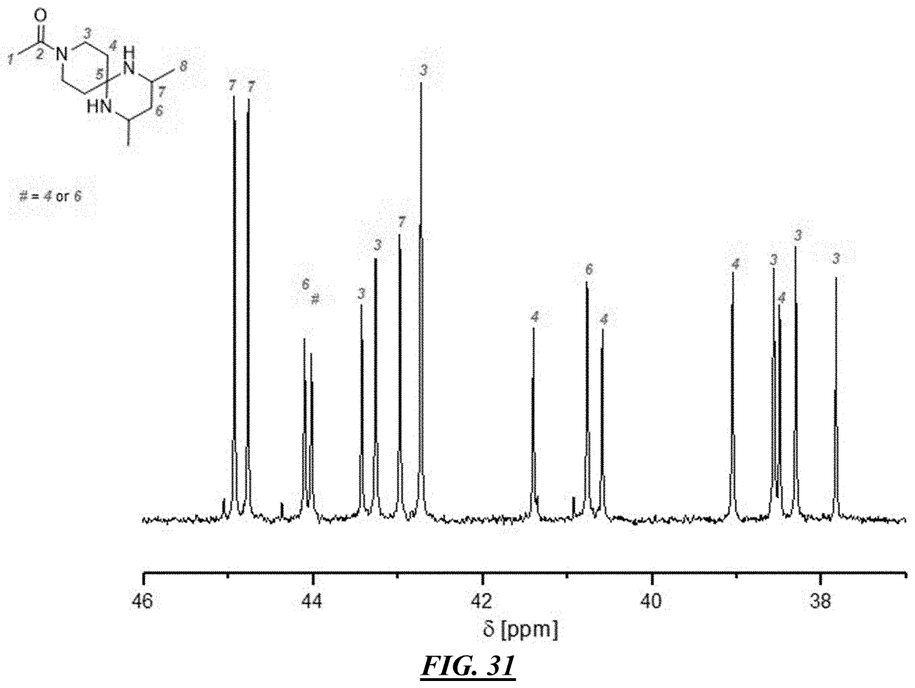

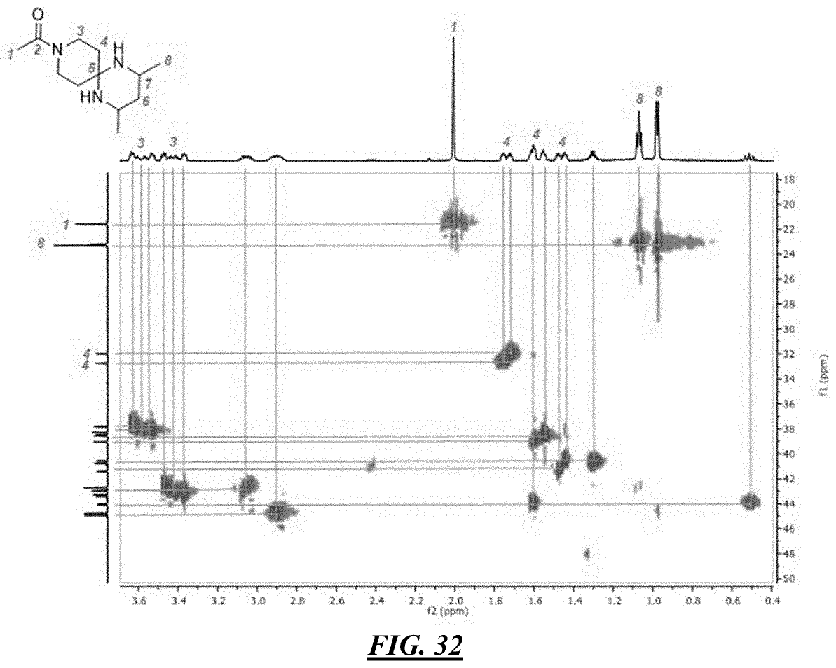

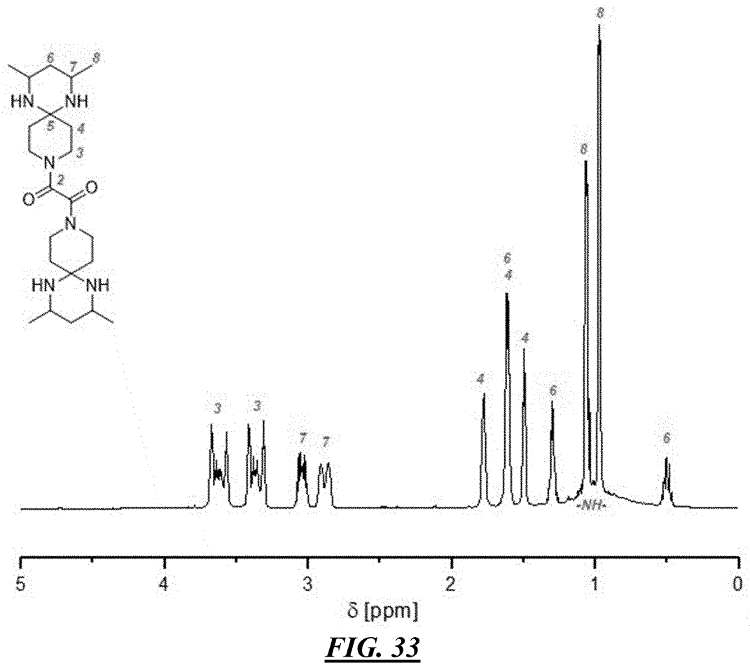

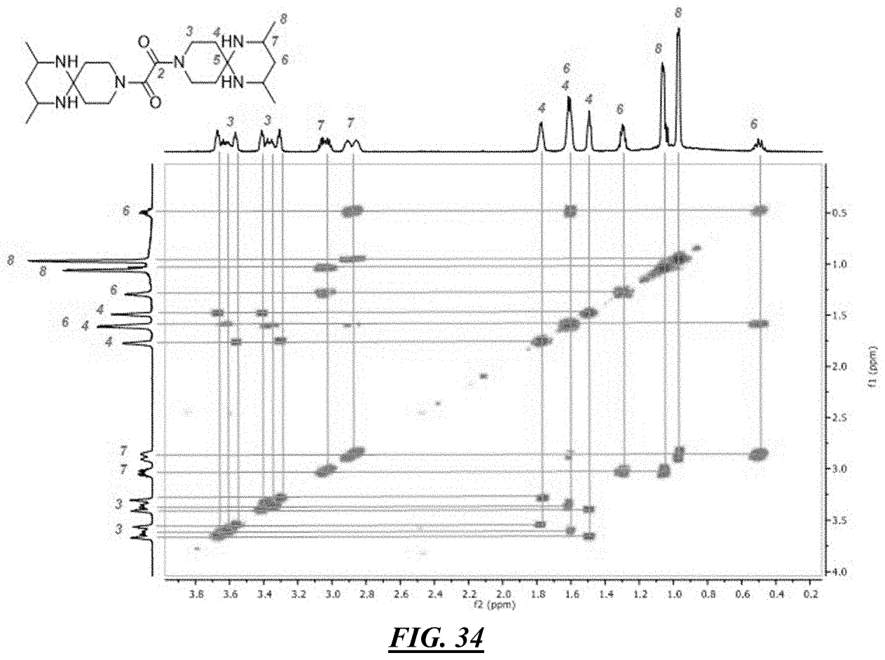

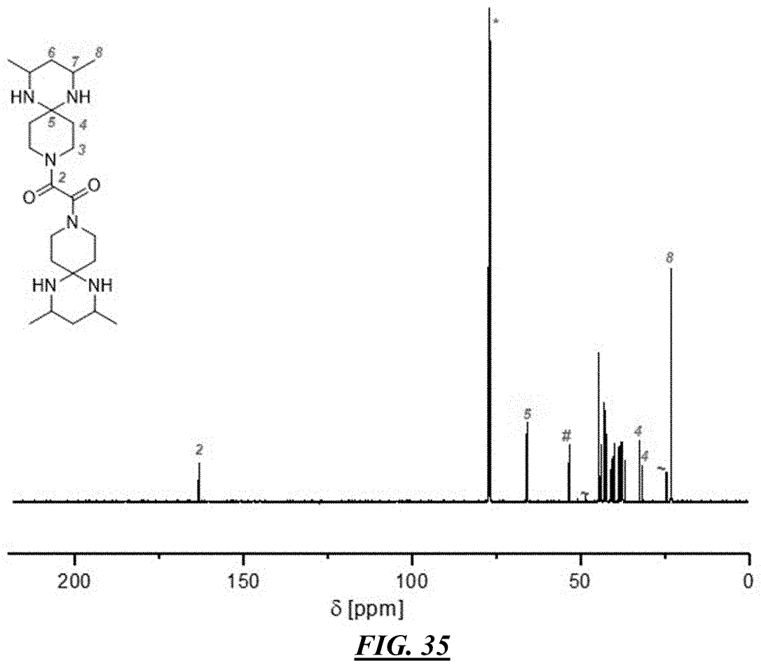

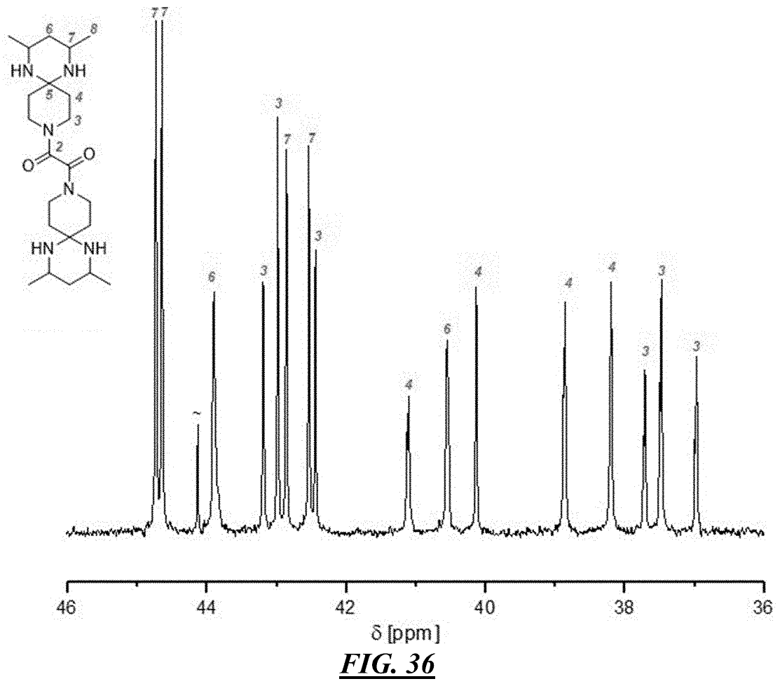

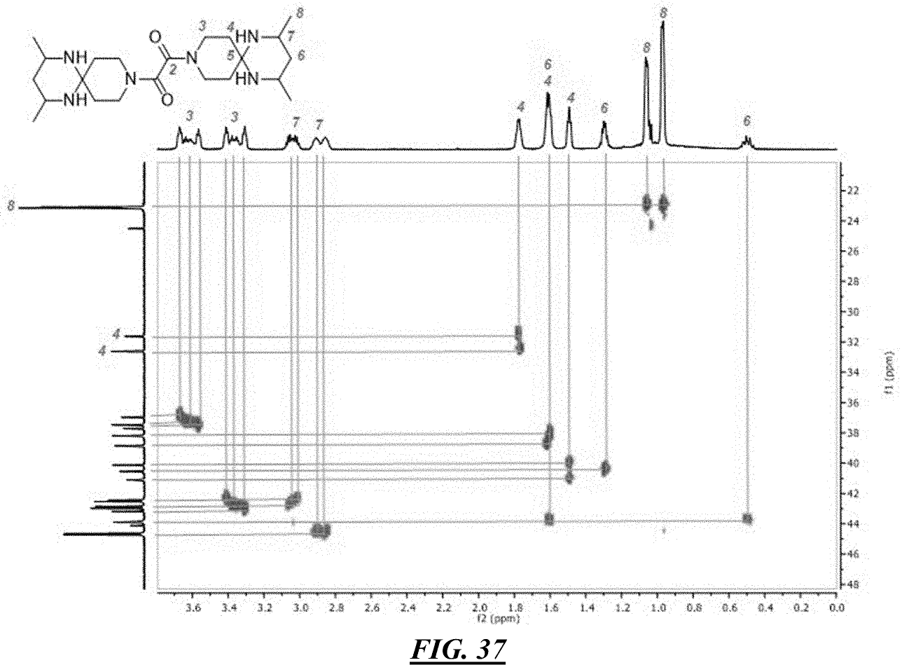

FIG. 16 shows ¹³C NMR spectra of the model compound 1,2-bis(2,4-dimethyl-1,5,9-triazaspiro[5.5]undecan-9-yl)ethane-1,2-dione (spectrum I) synthesized from DAPe and OBP and of the model compound 1-(2,4-dimethyl-1,5,9-triazaspiro[5.5]undecan-9-yl)ethanone (spectrum II) synthesized from DAPe and NAP. The shown spectra NMR spectra show the interesting range in which the aminal carbons provide signals. Three different signals can be detected, resulting from different stereoisomeric compounds. FIG. 17 shows all possible stereoisomers of the model compound 1-(2,4-dimethyl-1,5,9-triazaspiro[5.5]undecan-9-yl)ethanone that can form at room temperature. At room temperature three pairs of enantiomers are formed. The absolute number of stereoisomers results from the two chiral carbons of the used reactant (DAPe) and from the partial double bond character of the amide bond. The number of possible stereoisomers in the more complex model compound 1,2-bis(2,4-dimethyl-1,5,9-triazaspiro[5.5]undecan-9-yl)ethane-1,2-dione is twice as high. FIG. 29. Stereoisomers resulting from the reaction of DAPe and NAP.

8. Reaction of NAP with DAPr Under Different Conditions

NAP does not react with DAPr in water at neutral pH (see FIG. 18 III). At pH=12 a reaction to the aminal takes place (see FIG. 18 II). Aminal formation also takes place in methylene chloride (see FIG. 18 I). FIG. 18 shows ¹³C NMR spectra of the reactions of NAP with DAPr under different conditions measured in CDCl₃ @Bruker Avance Neo 600. *CHCl₃, ^{#}residual DAPr.

9. Effect of pH on the Reaction of PVAm with Ketones

FIG. 19 shows ¹³C NMR spectra of I) PVAm (Lupamin1595) crosslinked with OBP and measured in the gel state and II) PVAm (Lupamin1595) reacted with NAP at acidic, neutral and basic pH. At basic pH only aminal is observed, at acidic pH hemiaminal is formed. At neutral pH, a mixture of both will probably form, with hemiaminal appearing to predominate.

FIG. 19 includes ¹³C NMR spectra of PVAM-OBP gel (I) and PVAm solution reacted with NAP (II) measured in DMSO-d₆/H₂O at different pH @Bruker Fourier 300HD (I) and @Bruker Avance Neo 600 (II).

### 10. Effect of Crosslinking Density

FIG. 20 shows the ¹³C CP MAS NMR spectra of isolated PVAm—OBP gels. The gels were prepared at pH 7 and with different OBP concentrations. Increasing the ratio of OBP gives higher intensity of hemiaminal signals in the corresponding ¹³C CP MAS NMR spectra. Washing the gel with acetonitrile shifts the equilibrium towards aminals. This aspect is demonstrated by FIG. 20. In the ¹³C CP MAS NMR spectrum, only aminal signals at 67 ppm can be detected in the sample with a NH₂: C═O ratio of 10:1 (FIG. 20 III). In the solution state NMR spectra of the PVAm-NAP reaction, both a ratio of 20:1 and 10:1 do not show aminal signals at 67 ppm exclusively (FIG. 21 III).

FIG. 20 includes ¹³C CP MAS NMR spectra of isolated PVAM-OBP gels with different NH₂: C═O ratios. The gels were prepared at pH=7 and washed with acetonitrile @Bruker Avance 400.

FIG. 21 includes ¹³C NMR spectra of PVAm reacted with NAP with different NH₂: C═O ratios at pH=7 and measured in DMSO-d₆/H₂O @Bruker Avance Neo 600.

### 11. Reversibility of the Piperidone-PVAm Reaction

### 11.1 Temperature

¹³C NMR measurements at different temperatures of the PVAm gel synthesized with OBP show the reversibility of the crosslinking reaction. At room temperature, only the signals from the crosslinked polymer can be detected (see FIG. 22 I). As soon as the reaction mixture is heated to 70° C., additional signals at 94 ppm and 212 ppm are detected resulting from OBP (ketone and hydrate form, see FIG. 22 II). Subsequent cooling to room temperature again leads to a reaction of free OBP and PVAm and restores the network, the both signals vanished (see FIG. 22 III).

FIG. 22 includes ¹³C NMR spectra of PVAM-OBP gel measured in DMSO-d₆/H₂O at different temperatures and pH=7 @Bruker Fourier 300HD. * formate

### 11.2 pH Value

The pH dependent reversibility of the PVAm piperidone system can be demonstrated by ¹³C liquid NMR spectroscopy. Aqueous PVAm with pH=7 was placed in a NMR tube and NAP dissolved in DMSO-d₆ was added (see FIG. 23 II). Then a drop of 18% hydrochloric acid was added, mixed and after standing for 6 hours the reaction mixture was measured again by NMR spectroscopy (see FIG. 23 III). Then a drop of 18% sodium hydroxide solution was added, mixed and the reaction mixture was measured again by NMR spectroscopy after standing for 6 hours (see FIG. 23 IV). In spectrum III, additional signals appear at 94 ppm and 214 which can be assigned to free NAP (also the hydrated form). By subsequently increasing the pH value to 7 with sodium hydroxide, the shift of the equilibrium to hemiaminal formation can be observed. However, this reaction is incomplete, a small amount of free NAP is still visible in the spectrum, which could be caused by the salt concentration changed by the addition of hydrochloric acid and sodium hydroxide.

FIG. 23 includes ¹³C NMR spectra of PVAm reacted with NAP in DMSO-d₆/H₂O changing the pH from neutral to acidic and again to neutral @Bruker Avance Neo 600. * formate

It is contemplated that any and all combinations, components, systems, compositions, methods steps, components, reactions, reaction schemes, etc. described in this document, including in the following appendices, may be combined with any and all other combinations, components, systems, compositions, methods steps, components, reactions, reaction schemes, etc. described in this document, including in the following appendices. All combinations are hereby expressly contemplated for use herein in various non-limiting embodiments.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope of this disclosure.

What is claimed is:

1. A vinyl amine containing polymer comprising randomly distributed repeating monomer units having at least two of the following formulae: 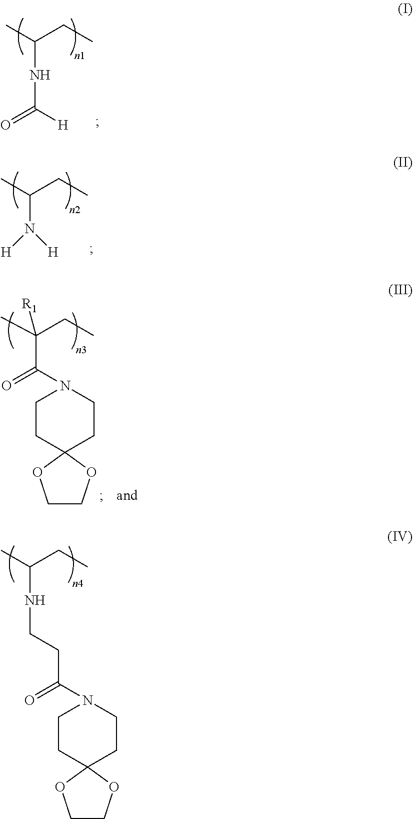
wherein, R1 is a hydrogen atom or a methyl group; and
wherein said vinyl amine containing polymer comprises repeating monomer unit III and/or IV in a total amount of from about 1.5 weight percent to about 8 weight percent based on a total weight of the polymer.

2. The polymer of claim 1 wherein repeating monomer unit (I) is present.

3. The polymer of claim 1 wherein repeating monomer unit (II) is present.

4. The polymer of claim 1 wherein repeating monomer unit (III) is present.

5. The polymer of claim 1 wherein repeating monomer unit (IV) is present.

6. The polymer of claim 1 wherein repeating monomer unit (I) is absent.

7. The polymer of claim 1 wherein repeating monomer unit (II) is absent.

8. The polymer of claim 1 wherein repeating monomer unit (III) is absent.

9. The polymer of claim 1 wherein repeating monomer unit (IV) is absent.

10. The polymer of claim 1 wherein R1 is a methyl group.

11. The polymer of claim 1 wherein R1 is a hydrogen atom.

12. The polymer of claim 1 wherein the repeating monomer unit III and/or IV is present in a total amount of from about 2 weight percent to about 6 weight percent based on a total weight of the polymer.

13. The polymer of claim 1 wherein the repeating monomer unit III and/or IV is present in a total amount of from about 2 weight percent to about 4 weight percent based on a total weight of the polymer.

14. The polymer of claim 1 wherein the repeating monomer unit III and/or IV is present in a total amount of from about 4 weight percent to about 6 weight percent based on a total weight of the polymer.

15. The polymer of claim 1 wherein the repeating monomer unit III and/or IV is present in a total amount of from about 6 weight percent to about 8 weight percent based on a total weight of the polymer.

16. A method of making the polymer of claim 1 wherein said method comprises the steps of:
reacting a polyvinyl amine and/or vinyl formamide based compound and a compound having a piperidine moiety to form an intermediate; and
acidifying the intermediate to form the polymer.

17. A method of making paper comprising the step of applying the polymer of claim 1 to pulp.
